(19) United States
(12) Patent Application Publication
(10) Pub. No.: US 2026/0285022 A1
(43) Pub. Date: Sep. 24, 2026

(54) WOODEN TRANSACTION CARDS AND METHODS OF MAKING THE CARDS

(71) Applicant: Copecto GmbH, Wiesbaden (DE)

(72) Inventor: David Finn, Fuessen Weissensee (DE)

(21) Appl. No.: 19/571,316

(22) Filed: Mar. 18, 2026

Related U.S. Application Data
(60) Provisional application No. 63/776,126, filed on Mar. 23, 2025.
(60) Provisional application No. 63/780,169, filed on Mar. 29, 2025.
(60) Provisional application No. 63/811,810, filed on May 25, 2025.
(60) Provisional application No. 63/811,792, filed on May 25, 2025.
(60) Provisional application No. 63/828,076, filed on Jun. 22, 2025.
(60) Provisional application No. 63/828,074, filed on Jun. 22, 2025.
(60) Provisional application No. 63/828,072, filed on Jun. 22, 2025.
(60) Provisional application No. 63/880,654, filed on Sep. 12, 2025.
(60) Provisional application No. 63/880,477, filed on Sep. 12, 2025.
(60) Provisional application No. 63/898,576, filed on Oct. 14, 2025.
(60) Provisional application No. 63/898,574, filed on Oct. 14, 2025.
(60) Provisional application No. 63/915,242, filed on Nov. 11, 2025.
(60) Provisional application No. 63/915,204, filed on Nov. 11, 2025.
(60) Provisional application No. 63/915,737, filed on Nov. 12, 2025.
(60) Provisional application No. 63/918,251, filed on Nov. 15, 2025.
(60) Provisional application No. 63/918,241, filed on Nov. 15, 2025.
(60) Provisional application No. 63/922,184, filed on Nov. 21, 2025.

(30) Foreign Application Priority Data
Mar. 12, 2026 (WO) PCT/EP2026/056889

(51) Int. Cl. B32B 37/10; B32B 7/12; B32B 21/06; B32B 21/14; B32B 37/00; B32B 37/12; B32B 38/00; G06K 19/077

(52) U.S. Cl. CPC B32B 37/10; B32B 7/12; B32B 21/06; B32B 21/14; B32B 37/0007; B32B 37/12; B32B 38/0004; G06K 19/07722; B32B 2307/718; B32B 2307/7376; B32B 2425/00

(57) ABSTRACT

A wooden transaction card (WTC) comprises a stack-up assembly of wooden (veneer) layers (WL, SWL, PWL), adhesive layers (AL), and a core substrate (support) layer (SL) incorporating a booster antenna circuit (BAC). The wooden layers are sliced (SWL) or rotary peeled (PWL). The wooden layers are preconditioned at the mill with a moisture content of 6-9% (dried-out timber) and are laminated together with the adhesive layers and support layer. The moisture content of the wooden layers changes during the lamination process.

### CROSS-REFERENCES TO RELATED APPLICATIONS

This application claims priority (filing date benefit) from the following as:
a continuation-in-part of PCT/EP2026/056889 filed 12 Mar. 2026 which claims priority from the following US provisional applications:
   U.S. 63/918,251 filed 15 Nov. 2025
   U.S. 63/915,204 filed 11 Nov. 2025
   U.S. 63/898,574 filed 14 Oct. 2025
a nonprovisional filing of U.S. 63/922,184 filed 21 Nov. 2025
a nonprovisional filing of U.S. 63/918,251 filed 15 Nov. 2025
a nonprovisional filing of U.S. 63/918,241 filed 15 Nov. 2025
a nonprovisional filing of U.S. 63/915,737 filed 12 Nov. 2025
a nonprovisional filing of U.S. 63/915,242 filed 11 Nov. 2025
a nonprovisional filing of U.S. 63/915,204 filed 11 Nov. 2025
a nonprovisional filing of U.S. 63/898,576 filed 14 Oct. 2025
a nonprovisional filing of U.S. 63/898,574 filed 14 Oct. 2025
a nonprovisional filing of U.S. 63/880,654 filed 12 Sep. 2025
a nonprovisional filing of U.S. 63/880,477 filed 12 Sep. 2025
a nonprovisional filing of U.S. 63/828,076 filed 22 Jun. 2025
a nonprovisional filing of U.S. 63/828,074 filed 22 Jun. 2025
a nonprovisional filing of U.S. 63/828,072 filed 22 Jun. 2025
a nonprovisional filing of U.S. 63/811,810 filed 25 May 2025
a nonprovisional filing of U.S. 63/811,792 filed 25 May 2025
a nonprovisional filing of U.S. 63/780,169 filed 29 Mar. 2025
a nonprovisional filing of U.S. 63/776,126 filed 23 Mar. 2025
   all of which are incorporated in their entirety by reference herein.

### FIELD OF THE INVENTION

This invention relates to transaction cards (also known as smartcards or smart cards, either of which may be referred to herein simply as “cards”) and, more particularly, to cards incorporating layers (or veneers) of wood, or other materials which may be eco-friendly or biodegradable. Cards having a significant wood content may be referred to as “wooden transaction cards”, or the like. This may include cards having contactless (RFID-enabled) capability or dual interface (contact and contactless) capability.

Some features of the invention(s) disclosed herein may include incorporating either a booster antenna BA (or booster antenna circuit BAC) or a coupling frame (CF) into the card to facilitate the contactless capability.

Cards incorporating a booster antenna (BA) are known, such as may be disclosed in U.S. Pat. No. 9,195,932 2015 Nov. 24 (Finn et al.), incorporated by reference herein

Cards incorporating coupling frames (CF) are known, such as may be disclosed in U.S. Pat. No. 9,390,364 2016 Jul. 12 (Finn et al.), incorporated by reference herein.

Some features of the invention(s) disclosed herein may include incorporating one or more of the following into the construction of the card: a laser engraved QR code, features which have been laser ablated or mechanically engraved, a magnetic stripe, a holographic foil, a topcoat protecting underlying artwork which can be laser etched with personalization data.

Some of the disclosure(s) herein may relate to transaction cards made from material other than wood.

### BACKGROUND OF THE INVENTION

Most of the wood cards for access control, such as those used as keycards in hotels have a thickness of 1.4 mm, and are unsuitable for use in the payment industry, requiring an ISO thickness of 0.76 mm±0.08 mm. And those “all wood” cards which are within ISO thickness bend easily and warp over time. To achieve card body stiffness and longevity, some producers have densified a stack of wood veneers comprising outer layers of wood veneer having a thickness of 600 μm and inner layers having a thickness of 200 μm, with the inner layers sandwiching an inlay incorporating an antenna circuit with a thickness of 100 μm, as disclosed in US 2024/0001585. However, there are a number of challenges in pre-conditioning to remove moisture and densifying a stack of wood veneers at stepped elevated pressure levels and the post manufacturing processes of impregnating, printing, coating, singulating, applying security elements, engraving features and implanting the chip module while at the same time achieving high production yields and keeping the manufacturing cost down. In use, wooden payment cards have also bowed, warped and delaminated in the field which has been a major concern for the issuing banks and payment schemes. As wooden cards are the eco-friendly alternative to PVC cards, durability and insensitivity to the environment, especially humidity is a prerequisite.

### Some Patents and Publications of Interest

The following patents and/or publications (“references”) may be of interest or relevant to the invention(s) disclosed herein, and some commentary may be provided to distinguish the invention(s) disclosed herein from the following references.

US 2024/0001585 (4 Jan. 2024; Swiss Wood Solutions; Chanana et al.), entitled “Densified hygroscopic materials and products made thereof”, incorporated by reference herein, discloses a method for densifying a hygroscopic material. The method is for hygroscopic material which may be a natural hygroscopic material or wood. The method comprises the steps of providing the hygroscopic material to be densified; pre-conditioning of the hygroscopic material by adjusting the moisture content of the hygroscopic material to a value within a predefined moisture range, if required; simultaneously heating and pressing the gas-tight packed hygroscopic material under predefined temperature and pressure conditions, whereby the moisture content of the hygroscopic material is kept constant; and obtaining a densified material. Reference is also made to WO 2022/112610 A1.

FIGS. 1, 3, 4 and 5 thereof are of particular interest, are reproduced as FIGS. 1, 2, 3 and 4 herein, and are discussed hereinbelow.

US 2022/0184931 (16 Jun. 2022; Kona I Co, Ltd.; Shin et al.), entitled “Card including wood sheet, and method of manufacturing the same”, incorporated by reference herein, discloses a method of manufacturing a card includes the steps of: processing a wood sheet; stacking the wood sheet on an inlay sheet including an antenna that will be connected to a COB chip; milling an area corresponding to the chip on the wood sheet, and forming a residual layer of a thickness smaller than that of the wood sheet; exposing end portions of the antenna passing through the residual layer from the inlay sheet located under the residual layer of the wooden sheet; and electrically connecting the chip and the end portions of the antenna. FIG. 1 is of particular interest, is reproduced as FIG. 5 herein, and is discussed hereinbelow.

US 2019/0311238 (10 Oct. 2019; Capital One; Cepress et al.), entitled “Multilayer composite backed card”, incorporated by reference herein, describes a transaction card. The transaction card may include a first card component of non-plastic card material having a thickness of no more than about 0.3 mm, a second card component of composite fiber material having a thickness of no more than about 0.3 mm, and an adhesive for affixing the first layer and second layer together. The non-plastic card material may be selected from a group including wood, bamboo, steel, copper, aluminum, silver, gold, platinum, granite, marble, and slate and the composite fiber material may include at least one of a glass fiber composite, a carbon fiber composite, or a natural fiber composite.

US 2010/0033297 (11 Feb. 2010; UPM Raflatac; Patovirta), entitled “Layered board structure”, incorporated by reference herein, discloses a layered board structure, which comprises at least two or more veneer layers, which are joined to one another by means of adhesive. In accordance with the invention, the layered board structure comprises further at least one intelligent identifier, which is arranged between said two veneer layers of the layered board structure.

US 2008/0020200 (24 Jan. 2008; Neenah Paper; Stokes et al.), entitled “Formaldehyde-free paper backed veneer products and methods of making the same”, incorporated by reference herein, discloses a paper backed veneer having a veneer laminated to a paper backing sheet saturated with a formaldehyde-free binder composition. The formaldehyde-free binder composition includes a curable latex polymer and a crosslinking agent. The latex polymer can include functionalized groups, such as carboxyl groups, to aid curing. The crosslinking agent can be an epoxy resin. Also, a method of making paper backed veneers is generally disclosed.

US 2008/0268273 (30 Oct. 2008; The Diller Corporation; O'Brien et al.), entitled “Wood veneer surfaced decorative laminate product and method of making same”, incorporated by reference herein, discloses a wood veneer surfaced laminate and method of making it are provided which produces a product having the appearance of a natural wood product, but with the toughness, moisture resistance, stain resistance, impact resistance, and abrasion resistance of melamine resin surfaced laminate products. The wood veneer surfaced laminate is made by providing a sheet of a natural or engineered wood veneer; impregnating the sheet with a first liquid curable resin such that said liquid resin substantially completely impregnates the sheet; coating a second liquid curable resin onto a surface of the sheet; laminating the sheet to a core while curing the resins to form a natural or engineered wood veneer surfaced laminate.

### Claim 1 of US 2008/0268273

A method of making a wood veneer surfaced laminate comprising, providing a sheet of a natural or engineered wood veneer; impregnating said sheet with a first liquid curable resin such that said liquid resin substantially completely penetrates said sheet; coating a second liquid curable resin onto a surface of said sheet; laminating said sheet to a core to form a natural or engineered wood veneer surfaced laminate; and curing said first and second resins.

U.S. Pat. No. 10,832,115 (10 Nov. 2020; Capital One Services, LLC; Suthar), entitled “Wood inlay card and method for making the same”, incorporated by reference herein, discloses a transaction card construction and a method for making a transaction card. The transaction card construction comprises an inlay component comprising wood and a housing component. The inlay may comprise a wood or wood-containing layer and a backer layer. The backer layer may comprise the same or a different wood or wood-containing layer, or a nonwoven fiber material. FIG. 11 is of particular interest, is reproduced as FIG. 6 herein, and is discussed hereinbelow.

U.S. Pat. No. 10,572,784 (25 Feb. 2020; Wells Fargo Bank; Kushner et al.), entitled “Wood transaction instrument”, incorporated by reference herein, discloses a method of manufacturing a densified wood transaction instrument includes boiling a sheet of wood in a chemical solution, compressing the boiled sheet of wood using a die in a press to form one or more features in the sheet of wood, during the compressing of the boiled sheet of wood, heating the boiled sheet of wood to create a sheet of densified wood, and attaching one or more payment elements to at least one of the one or more features formed in the sheet of densified wood to form a sheet of one or more densified wood transaction instruments.

U.S. Pat. No. 10,350,819 (16 Jul. 2019; Sappi North America; Murray), entitled “Release webs and textured products”, incorporated by reference herein, discloses processes and equipment for manufacturing materials that have a textured surface formed by applying a first texture to a curable coating, curing the coating, and then embossing a second, different texture over the first texture. The disclosure also features textured materials, including both release webs for use in replicative casting processes and finished products in sheet, board, plate or web form.

Claim 1 of U.S. Pat. No. 10,350,819

A release web comprising: a substrate; and a coating layer disposed on at least one surface of the substrate, the coating layer including a surface effect to be replicated during casting, wherein the surface effect comprises a first, predetermined micro- or nanoscale three-dimensional texture and a second, predetermined macro-scale three-dimensional texture; wherein the first texture is coextensive with the second texture.

U.S. Pat. No. 10,163,050 (25 Dec. 2018; Capital One Services, LLC; Suthar), entitled “Wood inlay card and method for making the same”, incorporated by reference herein, discloses A transaction card construction and a method for making a transaction card are provided for improving card performance. The transaction card construction comprises an inlay component comprising wood and a housing component. The inlay may comprise a wood or wood-containing layer and a backer layer. The backer layer may comprise the same or a different wood or wood-containing layer, or a nonwoven fiber material. Reference is also made to U.S. Pat. No. 10,354,180 (Suthar; 16 Jul. 2019), U.S. Pat. No. 10,354,179 (Suthar; 16 Jul. 2019), U.S. Pat. No. 10,152,670 (Suthar; 11 Dec. 2018).

U.S. Pat. No. 9,527,333 (27 Dec. 2016; Optimum Card Solutions; Lamb et al.), entitled “Unique method to manufacture paper substrate transaction cards”, incorporated by reference herein, discloses an in-line process is provided for economical manufacture of attractive flat paper substrate transaction cards with or without an RFID chip embedded therein. In the user-friendly process, one or more continuous webs from roller paper are automatically fed and sequentially advanced through a series of operations and stations in a single pass.

U.S. Pat. No. 8,192,830 (5 Jun. 2012; S.D. Warren Company; Blenkhorn et al.), entitled “Materials having a textured surface and methods for producing same”, incorporated by reference herein, discloses processes and equipment for forming a variety of textured materials, including both release webs, and finished products such as flooring materials, wall coverings, textured laminates and the like. The processes described herein allow curing radiation to be passed through a texturing medium, rather than through the substrate to which the curable material is applied.

Claim 1 of U.S. Pat. No. 8,192,830

A textured product comprising: a substrate comprising a board or plate; and on the substrate and forming an exposed surface of the product, a cured radiation curable coating having a three dimensional surface texture that reproduces an original three-dimensional pattern with 100% fidelity; wherein the physical properties of the substrate, which has the cured radiation curable coating thereon, are substantially the same as the physical properties of the substrate prior to application and curing of the coating.

U.S. Pat. No. 8,579,201 (12 Nov. 2013; Sustainable Cards; Akesson), entitled “Hybrid cards”, incorporated by reference herein, discloses a hybrid card. The hybrid card includes an organic substrate, a first layer of a substantially organic backer that is securely affixed to a first side of the substrate, a second layer of a substantially organic backer that is securely affixed to an opposite side of the substrate, a first layer of thin-film overlay that is attached to the first layer of backer, a second layer of thin-film overlay that is attached to the second layer of backer. Manufacturing methods for the various embodiments of the hybrid card are also described. Reference is also made to US 2011/0311787.

Claim 1 of U.S. Pat. No. 8,579,201

A hybrid card comprising: a core consisting of a single layer wood substrate; a first layer of a substantially organic backer made from a long-fibrous cellulose material, the first layer being securely affixed to a first side of the core, the first layer being substantially transparent to render the structure of the core visible through the first layer of substantially organic backer; a second layer of a substantially organic backer made from a long-fibrous cellulose material, the second layer being securely affixed to an opposite side of the core, the second layer being substantially transparent to render the structure of the core visible through the second layer of substantially organic backer; a first layer of thin-film overlay that is attached to an outer surface of the first layer of backer; and a second layer of thin-film overlay that is attached to an outer surface of the second layer of backer.

U.S. Pat. No. 7,404,422 (29 Jul. 2008; Eagle Analytical; Kamke et al.), entitled “Viscoelastic thermal compression of wood”, incorporated by reference herein, discloses a high density wood product that is made from low-density wood. The wood product is made using a continuous viscoelastic thermal compression (VTC) process and exhibits high density, strength and dimensional stability, compared to the lower density starting material (typically composite panels such as strand board) from which it is made.

U.S. Pat. No. 5,652,065 (29 Jul. 1997; Weyerhaeuser; Park et al.), entitled “Wood veneers and products therefrom having enhanced strength and stiffness”, incorporated by reference herein, discloses wood veneers having enhanced strength and/or stiffness, wood products made therefrom, and methods for manufacturing such veneers and wood products. A treated veneer having enhanced strength and stiffness has a population of compacted wood cells extending across at least a portion of the length and width dimensions and into the thickness dimension of the veneer to confer an increased density level, and thus increased strength and/or stiffness levels, to the veneer. Interspersed in the compacted wood cells is a non-saturating loading level of a cured rigid thermoset material which maintains compaction of the compacted cells even after prolonged soaking in water. The preferred loading level is just what is required to maintain compaction of the cells. The preferred thermoset material is polyurea which is formed from a polyisocyanate resin applied to at least one major surface of the veneer followed by hot-pressing the veneer. The strength and/or stiffness increase, compared to untreated veneer, is about 10 to 150 percent. Treated veneers can be made into various multiple-ply wood products such as laminated veneer lumber and plywood, thereby providing a way to convert relatively weak lumber from fast-grown trees into premium-grade construction material.

WO 2019/115727 (14 Dec. 2017; Gemalto; Kodjagueuzian et al.), entitled “Method for producing a chip card comprising wood”, incorporated by reference herein, discloses a method for producing a chip card (10A, 11A) comprising a card body (17) comprising wooden sheets (5B, 6B), said method comprising the steps of: providing two wooden sheets (5B, 6B); providing an insert (1) comprising at least one sheet or leaf of metal (3); and inserting the insert (1) between said sheets (5B, 6B) before assembly of all of the elements, the outer faces of the wooden sheets being outwardly oriented and predominantly covering the two main surfaces of the card body (17), said method being characterised in that it comprises a step of printing (15) or fixing a layer of material (14) onto the edge (T) of the card body (17), which is designed to interconnect layers in the region of the edge. The invention also relates to a corresponding card produced by the method.

WO 96/23276 (1 Aug. 1996; Eco-Card Sweden AB; Zetterlund et al.), entitled “Card”, incorporated by reference herein, discloses a card (1; 1′) comprising at least one information carrier (6; 6′), for example a telephone card or a credit card, wherein the card (1; 1′) comprises at least two layers (8, 9; 8′, 9′) made of wood connected to each other, wherein each layer (8, 9, 10; 8′, 9′, 10′) has a main fiber direction and that the fiber directions of the layers (8, 9, 10; 8′, 9′, 10′) are orientated in at least two different directions. Reference is also made to PCT/SE96/00063.

EP 3985563 (20 Apr. 2022; Exceet Card Austria GmbH—Skidata GmbH; Irlinger et al.), entitled “Chip card”, incorporated by reference herein, discloses a chip card (1) comprising a chip (9) which is designed as a layered composite, the visible sides (2) of which are designed as layers of wood veneer, with a core designed as a prelaminate (3) being arranged between the visible sides (2) which has a paper substrate (4) connected on both sides to a layer (5) of paper or cardboard, on which the chip (9) and, if present, an antenna (10) are arranged.

### Claim 1 of EP3985563A1

Chip card (1) comprising a chip (9), characterized in that it is designed as a layered composite whose visible sides (2) are designed as layers of wood veneer, with a core designed as a prelaminate (3) being arranged between the visible sides (2), which has a paper substrate (4) connected on both sides to a layer (5) of paper or cardboard, on which the chip (9) and, if present, an antenna (10) are arranged. Chip card (1) according to Claim 1, characterized in that an intermediate layer (6) of nonwoven material is provided between the prelaminate (3) and the respective visible side (2) of the chip card (1) made of wood veneer.

EP 4 506 853 (12 Feb. 2025; Giesecke & Devrient; Fernandez et al.), entitled “Method for manufacturing a smart card with a wooden layer”, incorporated by reference herein, discloses a method (150) for manufacturing a smart card (10). The method comprises: in a first step (152), providing a front layer (111), a rear layer (112), and an antenna layer (113) of a smart card body (11), wherein at least the front layer (111) comprises wood; in a second step (154), applying thermal energy to the front layer (111) by a thermal energy source (50, 70, 80) in order to heat the front layer (111) for a first predetermined period of time to a first predetermined temperature; in a third step (156), joining the front layer (111), the rear layer (112), and the antenna layer (113) with the antenna layer (113) being arranged between the front layer (111) and the rear layer (112). The third step (156) is carried out after the second step (154) and prior to the front layer (111) being joined with the antenna layer (113).

DE 198 03 262 C2 (27 Apr. 2000; Dexle et al.), entitled “Veneer system of high flexibility and method for producing same”, incorporated by reference herein, discloses in the set of claims the following: 1. Use of a single fleece for backing veneer systems, characterized in that the single fleece is hydroentangled. 2. Use of a single fleece according to claim 1, characterized in that the single fleece has a splitting strength of more than 450 kPa with a thickness of more than 0.1 mm. 3. Use according to claim 1 or 2, characterized in that the single fleece is a wet fleece. 4. Use according to claim 3, characterized in that the single fleece is a mixture of cellulose and polyester fibers bound with a binder, preferably an acrylate dispersion. 5. Use according to claim 1 or 2, characterized in that the single fleece is a dry nonwoven. 6. Use according to claim 5, characterized in that the dry nonwoven includes polyester fibers or other plastic fibers. 7. Use according to one of claims 1 to 6, characterized in that the single fleece comprises a coating. (translated from German)

### Additional References

CN 112567386A entitled “Card comprising a wood laminate and method for making same”;
JP 7149335B2 entitled “Card with wooden sheet and its manufacturing method”;
WO 2024144271A1 entitled “Solid-wood card having chip equipped therein”;
KR 20230031722A entitled “Solid wood card attached chip”;
KR 102621194B1 entitled “Solid wood card attached chip”;
KR 20160042568A entitled “Hybrid card having wood sheet and preparing method for the same”;
KR 20190012296A entitled “A sliced veneer credit card process and sliced veneer credit card”;
KR 20230000101A entitled “Wooden card and manufacturing method thereof”;
KR 20240107305A entitled “Wood card to be embedded chip”; and
US 20160004948A1 entitled “Method for producing a paper carrier card with removable integrated chip module card, and paper carrier card made of paper with removable integrated chip module card”.

### SUMMARY

Cards incorporating wood layer(s) are known, such as may be shown in the following patent publications, incorporated by reference herein: WO 96/23276, WO 2022/112610, U.S. Pat. Nos. 8,579,201, 10,572,784, 10,832,115, US 2010/0033297, US 2019/0311238 and US 2022/0184931.

It is an object of the invention to compress a stack of wood veneer layers (or “wooden layers”, or “wood layers”), adhesive layers and reinforcement layers in forming a transaction card, which has desirable properties with regard to dimensional stability (e.g. uniform thickness, flatness, shape memory effect, substantially no warpage, low swelling and shrinking when exposed to humidity, moisture and wetness), increased hydrophobicity (e.g. low moisture/water adsorption, increased water-repellency, low wettability), increased hardness and scratch-resistance, and color-stability against ultraviolet (UV) and visible (VIS) light and/or temperature changes.

According to the invention, generally, a wooden transaction card (smartcard (SC); WTC) comprises a stack-up assembly comprising several wood veneer layers (WL), adhesive layers (AL) for interlayer bonding and a core substrate (CS) layer incorporating a booster antenna circuit. The wood veneer layers may be sliced or rotary peeled, preconditioned at the mill with a moisture content of 6-9% (ideally 8%) (dried-out timber; after drying at the mill). A stepped module opening extends into the layers for implanting a transponder chip module for inductive coupling with the coupler coil of the booster antenna circuit. A single press lamination cycle entails a compression process of reducing the stack-up assembly of wood veneer layers, adhesive layers and the core substrate layer (SL) to an ISO conforming thickness of 760-800 μm (before applying impregnation layer (IL), artwork (AW) and topcoat (TC)) A pressure of 850 N/cm² may be applied at a temperature between 135° C. and 165° C. for a duration between 30 and 50 minutes. During press lamination, the melted adhesive film in resin form flows through the pores of wood veneer to the outer exposed layers (front and rear) leaving a closed surface finish. The stack-up assembly is laminated at very high pressure between a top and bottom sacrificial layer which imparts or induces a very smooth surface roughness. The surface may be plasma activated to change the wettability (contact angle) allowing for the later deposition of UV ink. The inner and outer wood veneer layers (WL) may be colored or non-colored (stained or unstained), and the adhesive layers may or may not be pigmented.

According to an embodiment of the invention, some or all of the following steps may be performed to make laminated card bodies for smartcards: providing preconditioned wood veneer layers of different wood species with a moisture content of 6-9% (ideally 8%) (after drying the wood veneers at the mill); producing wood veneer layers from wood logs using different cutting techniques (rotary peeled or sliced) resulting in different thicknesses ranging from 125 μm to 550 μm (taking thickness tolerances into account); selecting different cuts of wood species in the stack-up construction of the card body assembly; selecting stained or unstained wood veneer layers (inner and outer layers) in the stack-up construction of the card body assembly; selecting interlayers of adhesive for bonding and substrate layers for reinforcement; laminating the stack-up assembly without a pre-conditioning cycle to remove moisture content; selecting lamination parameters in a continuous press lamination cycle (hot and cold) to compress the material layers in the stack-up assembly to an ISO conforming thickness of 760-800 μm; and before press lamination modifying or varying the thicknesses of the material layers, adjusting the pressure to achieve a certain degree of shrinkage to achieve an ISO conforming thickness, with the ultimate objective to reach a card body weight of 4 grams (pressure and material thickness dependent).

According to an embodiment of the invention, a stack-up assembly (laminated sheet assembly for producing smartcard bodies) of wood veneer layers (or wood layers, or wooden layers; WL) and adhesive layers (AL) may be laminated with the internal layers of adhesive melting, seeping through and filling the pores of the front and rear wood veneer layers, with sacrificial layers (on each side of the assembly) acting as a back-stop to stop the the flow of adhesive resin through the top and bottom (front and rear) external wooden layers to create a glass-like surface finish on external (exposed) surfaces of the front and rear wooden layers of the card bodies, post lamination of the assembly. The resulting glass-like surface finish may be activated (prepared for printing) by plasma surface modification or application of a primer to allow for the later deposition of digital ink in creating graphic artwork (AW) on the front and rear surfaces of the smartcard body.

According to an embodiment of the invention, the laser engravable topcoat (TC) protects the digitally printed artwork (AW) and facilitates the adhesive attachment of the magnetic stripe (MS) and hologram (H) to the card body (CB).

According to an embodiment of the invention, a highly compressed laminated sheet assembly (LSA) of multiple wood veneer layers (e.g. 4 layers (WL)), adhesive layers (e.g. 4 layers (AL)) as interlayers for bonding and a core substrate layer (SL), with the stack-up sheet assembly having an array of card body sites in a production format (e.g. 3×8 (24-up), 5×5 (25-up), 6×8 (48-up), etc.) incorporating a booster antenna circuit (BAC) at each card body position, and the sheet assembly having a top and bottom exposed (wood veneer) surface (front and rear face) covered with a sacrificial layer (top and bottom) to prevent (block) the flow of resin from the inner layers of the stack-up assembly contaminating the (glossy or matt) lamination plates (platens) during press lamination and removed post lamination; wherein said top and bottom sacrificial layer (SFL) imparting or inducing a (glossy or matt) polymeric surface finish of a certain roughness to the exposed wood veneer layers (on each side of the laminated sheet assembly) resulting from the flow of molten resin penetrating the pores of the wood veneer layers and reaching the outer surfaces of the stack-up assembly covered by the top and bottom sacrificial layer (SFL); wherein the exposed wood veneer layers (top and bottom) may have a very smooth surface roughness of Ra<1 μm requiring surface treatment to change the wettability (contact angle) allowing for the later deposition of UV ink; wherein said top and bottom exposed surface with a very smooth finish (depending on the surface roughness of the sacrificial layer (SFL) and the choice of lamination parameters) may be plasma activated before digital printing or alternatively the exposed surfaces may be coated with a primer (post lamination of the sheet assembly) for impregnation (waterproofing) and surface treatment (adhesion promoter) to receive the later deposition of digital ink; and wherein said top and bottom exposed surface with a very smooth finish may be laser etched (CO₂ laser) to produce graphic elements.

The wood veneer layers (WL) in the stack-up sheet assembly comprise outer exposed layers (front and rear) of sliced wood veneer (SWL/maple: 550 μm) and intermediate layers of micro thin rotary peeled wood veneer layer (PWL/maple or birch: 200 μm), delivered by the mill (pre-conditioned) with a moisture content (MC) in the range of 6 to 9 percent (drying process—dried-out timber). The assembly further comprising a core substrate layer (SL: 100 μm) of paper, polymers or composites, and four adhesive layers (AL: thermoplastic adhesive such as PVAc) for interlayer bonding, each having a thickness of 25 μm. An array of booster antenna circuits (BAC) formed by wire embedding into the core substrate layer (SL) using multiple ultrasonic tools (sonotrodes).

The total thickness of the individual layers forming the stack-up sheet assembly (two (front and rear face) sliced wood veneer layers (SWL), two (upper and lower) intermediate layers of rotary peeled wood veneer (PWL, IWL), a core substrate layer (SL) incorporating an array of booster antenna circuits (BAC) and four adhesive layers (AL)) before press lamination, may be approximately 1700 μm. The post lamination thickness of the laminated sheet assembly (LSA) may be approximately 760-800 μm, representing a shrinkage of approximately 53%. The post laminated assembly may be a solid homogenous sheet which cannot be delaminated (individual layers strongly resist being delaminated) to reveal individual layers, achieved through the composition of material and adhesive layers forming the stack-up and the compression process of laminating in a single process step with defined lamination parameters to achieve a card body weight of 4-4.5 grams (including the implanted chip module, which may have a weight of 0.1 grams) and an ISO conforming thickness of 760-800 μm.

The lamination step of the complete stack-up assembly (4-ply) may be a single continuous lamination process (linear, gradual or exponential) using a very high pressure between (8.5-12.5 MPa (850 N/cm² and 1250 N/cm²) at a temperature between 135° C. and 150° C. (depending on the type of adhesive) for a duration between 30 and 50 minutes followed by a cooling cycle to ambient pressure and temperature. For example, a very high pressure of 12.5 MPa (1250 N/cm² or ~127.5 kg per cm²) across an area of 360 mm×605 mm (e.g. representing a production format of 3×8) equates to approximately 278 tons of compression or densification.

According to an embodiment of the invention a 4 ply stack-up construction comprising outer layers of sliced wood veneer (front and rear) with a thickness of 550 μm; bonded with adhesive layers (upper and lower) with a thickness of 25 μm to intermediate layers of rotary peeled wood veneer (top and bottom) with a thickness of 200 μm; and said intermediate layers bonded via 25 μm adhesive layers (upper and lower) to a core substrate layer of paper or fleece with a thickness of 100 μm incorporating a wire embedded antenna circuit; with the complete assembly having a thickness of 1700 μm before press lamination; wherein the post-lamination thickness is determined by a combination of lamination parameters, wood species, type of cut (rotary peeled or sliced), grain direction, number, thickness and density of the wood veneer layers, and the lamination method; wherein laminating the stack-up assembly with an overall thickness of 1700 μm at a pressure under 850 N/cm², a temperature of 150° C. and a dwell time of 30 to 50 minutes to form a laminated assembly having an ISO-conforming post-lamination thickness of 760-800 μm (before application of a primer, artwork and top coat) representing a shrinkage of 53 to 55%, and resulting in a card body weight of approximately 4.5 grams (including the implanted chip module);

Alternatively, reducing the thickness of the outer wood layers (front and rear) to 450 μm and the inner wood layers (top and bottom) to 150 μm with the stack-up assembly having an overall thickness of 1400 μm (before press lamination), and laminating the assembly at a pressure under 500 N/cm², a temperature of 150° C. and a dwell time of 30 to 50 minutes to form a laminated assembly having an ISO-conforming post-lamination thickness of 760-800 μm (before application of a primer, artwork and top coat) representing a shrinkage of 43 to 45%, and resulting in a card body weight of approximately 4.0 grams (including the implanted chip module).

According to an embodiment of the invention, a stack-up construction as described above with an initial thickness of 1700 μm, may be laminated at a pressure of 850 N/cm² or 1250 N/cm² at a temperature of approximately 150° C. (between 135° C. and 165° C., depending on the type of adhesive) for a dwell time of 30 minutes resulting in an ISO conforming thickness of 760-800 μm before application of a primer PR or impregnation layer IL, artwork AW and a topcoat TC (representing a shrinkage of 53%) at both pressure levels, without a preconditioning cycle to remove moisture. Therefore, a press lamination pressure of 850 N/cm² at a temperature of approximately 150° C. (between 135° C. and 165° C., depending on the type of adhesive) for the abovementioned stack-up construction represents a threshold point in the compression process, with the duration of the dwell time (30 or 50 minutes) regulating the color of the surface finish on both sides of the card body.

According to an embodiment of the invention, a stack-up construction as described above with an initial thickness of 1700 μm may be laminated at a pressure of 850 N/cm² at a temperature of approximately 150° C. (between 135° C. and 165° C., depending on the type of adhesive) for a dwell time between 30 and 50 minutes resulting in an ISO conforming thickness of 760-800 μm (representing a shrinkage of 53%) without a preconditioning cycle to remove moisture.

If the thickness of the stack-up assembly is reduced (from 1700 μm to 1400 μm), the pressure during lamination may also be reduced from 850 N/cm² to 500 N/cm² resulting in an ISO conforming thickness of 760 μm to 800 μm, and the weight of the card body may decrease from 4.5 grams to slightly under 4 grams.

According to an embodiment of the invention, the final thickness of the assembly (post lamination) is determined by the lamination parameters (pressure, temperature, and dwell time), but it is also dependent on the number of material layers and their constitution, the type and thickness of wood species in the stack-up construction of the assembly, and the manner in which the stack-up assembly is laminated, single stack or multiple stack lamination. The dwell time to laminate multiple stacked assemblies which are disposed atop one another is significantly longer than a single stack-up assembly, at the same pressure and temperature.

Post lamination, the laminated sheet assembly (LSA) may receive magnetic stripes (MS). In reducing the laminated sheet assembly (LSA) to card bodies (singulation process), the sheets may be CO₂ laser cut, punched or CNC milled. The singulated card bodies may receive a milled-out pocket (stepped recess (P₁ and P₂) to accept the implanting of a chip module (CM) or a transponder chip module (TCM). The milled-out pocket may have a surface roughness (Ra) of approximately 6 μm. Index holes and or fiducials may be provided for later alignment of the laminated sheet assembly (LSA).

The resultant card bodies are substantially (completely) flat (without warpage) with a defined stiffness, breakage point and a weight of approximately 4 grams. See, for example, FIGS. 8 to 10.

According to an embodiment of the invention, the stack-up assembly of a 5-ply wooden smartcard may comprise a front sliced wood veneer layer (SWL) coated on its underside with a thermoplastic adhesive and a rear sliced wood veneer layer (SWL) coated on its topside with a thermoplastic adhesive for interlayer bonding with a core subassembly (CS), with the front and rear (exposed) wood veneer layers (SWL) sandwiching a core subassembly (CS) comprising an upper and lower rotary peeled wood veneer layer (uncoated PWL) with a middle layer of rotary peeled wood veneer coated on both sides with a coating of thermoplastic adhesive, also referred to as an adhesive coated wood (ACW), wherein a booster antenna circuit is incorporated into at least one of the coating layers applied to the middle rotary peeled wood veneer layer, and wherein the thickness of the adhesive coating (AC) is increased to facilitate the process of wire embedding and improved interlayer bonding. See, for example, FIG. 11.

According to an embodiment of the invention, a multi-layered transaction card comprising layers of wood veneer of different species or layers of wood veneer of different color (individually stained or dyed) may receive graphic features or alphanumeric characters to its exposed surfaces by a method of mechanical engraving, laser ablation or chemical etching. In forming the features or characters, the removal process passes from an exposed surface layer to an underlying surface layer in revealing a different wood species or a different colored wood veneer. The removal of wood fiber may create a recess or a protrusion of the features or characters in or on the card body. Put differently, a black front surface layer of a multilayered (wooden) transaction card may be machined to reveal an underlying layer having a bright color, creating a distinctive contrast between the exposed dark color and the internal bright vibrant color. The depth of removal may be 50 μm, 100 μm or 150 μm. In forming the features or characters by way of laser ablation, the light source parameters (wavelength (nm), power (watt), spot size (μm), overlap (%), scanning speed (mm/s) and pulse rate (kHz)) may be used to change the color of the wood fiber during ablation resulting in oxidation. The removal technique may be regarded as a unique form of card personalization.

According to an embodiment of the invention, front and rear subassemblies (FS & RS) may be mounted to a core subassembly (CS) in forming the stack-up construction of a card body (CB), wherein the core subassembly (CS) comprises dyed (colored) wood (veneer) layers which provide background contrast to the exposed non-colored (natural wood colored) front and rear wood layers. The exposed front and rear wood layers may be laser etched to have openings (apertures, slits, slots) extending therethrough to reveal the underlying colored wood veneer. Put differently, the front and rear non-colored sliced wood veneer (SWL) may be machined to reveal the underlying-colored rotary peeled wood veneer (PWL). The color of the inner rotary peeled wood veneer (PWL) may reflect through the non-colored sliced wood veneer (SWL).

For a given stack-up construction of material layers in forming a card body structure having a thickness before press lamination of 1650 μm (front non-colored SWL (Maple: 300 μm)+AL (25 μm)+colored PWL (Maple: 425 μm)+AL (25 μm)+core SL (100 μm) with BAC+AL (25 μm)+colored PWL (Maple: 425 μm)+AL (25 μm)+non-colored rear SWL (Maple: 300 μm), the post lamination thickness in applying a pressure of 850 N/cm² at a temperature of approximately 150° C. (between 135° C. and 165° C., depending on the type of adhesive) for a dwell time of 30 minutes is approximately 760-800 μm (representing a shrinkage of 52%). See, for example, FIG. 12A.

According to an embodiment of the invention, the front and rear layer of rotary peeled wood veneer (PWL) may be assembled to a core subassembly (CS) comprising layers of dyed sliced wood veneer (SWL) which provide background contrast to the exposed non-colored wood veneers. The thicker sliced wood veneers (SWL) forming the core may also provide mechanical strength to the card body construction.

For a given stack-up construction of material layers in forming a card body structure having a thickness before press lamination of 1700 μm (front PWL (Maple: 200 μm)+AL (25 μm)+SWL (Maple: 550 μm)+AL (25 μm)+core SL (100 μm) with BAC+AL (25 μm)+SWL (Maple: 550 μm)+AL (25 μm)+rear PWL (Maple: 200 μm), the post lamination thickness of the assembly, in applying a pressure of approximately 850 N/cm² at a temperature of approximately 150° C. (between 135° C. and 165° C., depending on the type of adhesive) for a dwell time of approximately 30 minutes is 760-800 μm (representing a shrinkage of 53%) without a preconditioning cycle to remove moisture. See, for example, FIG. 12B.

All dimensions and process parameters provided herein should be considered to be approximate and exemplary (“ideal”). For example, as used in the various embodiments described herein:
a nominal thickness of 550 μm for the outer wooden layers may range from thicknesses of 525 μm to 575 μm;
a nominal thickness of 200 μm for other (intermediate) wooden layers, which may comprise micro-thin rotary peeled wood veneer layers, may range from 175 μm to 225 μm (ideally 200 μm);
a thickness of 100 μm (such as for the core substrate layer (SL) may range from 90 μm to 110 μm;
a thickness of 25 μm for the adhesive layers (AL) may range from 20-30 μm; and
a shrinkage of 53% may range from 50% -55%.

With several wooden (and other) layers performing different roles in the stack-up of the card body, it should be understood that the thicknesses of individual layers may vary, the ultimate goal being to achieve a post lamination thickness for the card body of 760 μm to 800 μm (exclusive of impregnation layer (IL), artwork (AW) and topcoat (TC)).

The layers of wood veneer forming the card body construction as mentioned above may be replaced by heat and steam treated wood veneers which are water resistant, also known as ThermoWood.

According to an embodiment of the invention, the wood veneer layers may be sliced or rotary peeled and may be prepressed. For example, the sliced wood layers (SWL) may be compressed to 50% of their original thickness in a prepress process, before final lamination of the complete stack-up assembly. See, for example, FIG. 13A.

According to an embodiment of the invention, the wood veneer layers (sliced and rotary peeled) forming the stack-up construction of the wooden transaction card (WTC) may be reduced in thickness (thinned) to accommodate a lower lamination pressure below (less than) 5 MPa (500 N/cm²) resulting in a lower material shrinkage to achieve an ISO complaint thickness of 760-800 μm, with the moisture content (MC) of the wood veneer layers (WL) fluctuating or changing under the application of temperature and pressure.

In their various embodiments, the invention(s) described herein may relate to industrial and commercial industries, such RFID applications, payment smartcards, electronic credentials, identity cards, loyalty cards, access control cards, key-cards, biometric cards, and the like.

The inventions described herein may relate to innovations in or improvements to RFID enabled, wood-containing transaction cards, and may also relate to methods of improving the environment such as by reducing or eliminating the plastic content of transaction cards (or smartcards, or smart cards).

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements and (sub)assemblies may be referred to with letters (“CB”, “CBS”, “CS”, “FS”, “MO”, MS”, “R”, “RS”, “SC, “TCM”, “WL”, etc.) rather than or in addition to numerals. Some similar (including substantially identical) elements in various embodiments may be similarly numbered, with a given numeral such as “310”, followed by different letters such as “A”, “B”, “C”, or “a”, “b”, “c”, etc. (resulting in “310A”, “310B”, “310C” or “310a”, “310b”, “310c”), and may collectively be referred to simply by their common numeral (“310”).

FIG. 1 (compare FIG. 1 of US 2024/0001585) is a laminated structure consisting of four rectangular layers of densified wood veneer whereby adjacent layers have different wood grain directions, according to the prior art;

FIG. 2 (compare FIG. 3 of US 2024/0001585) is a partial view of the cross-section of a card, according to the prior art;

FIG. 3 (compare FIG. 4 of US 2024/0001585) is an exploded assembly drawing of a card with electronic functionality, according to the prior art;

FIG. 4 (compare FIG. 5 of US 2024/0001585) is a perspective view of a card with electronic functionality, according to the prior art;

FIG. 5 (compare FIG. 1 of US 2022/0184931) is a perspective view showing a wooden card, according to the prior art;

FIG. 6 (compare FIG. 11 of U.S. Pat. No. 10,832,115) is a schematic diagram depicting a wood-on-wood inlay, according to the prior art;

FIG. 7A (compare FIG. 1 of U.S. Pat. No. 6,233,818) is a schematic representation of the scribing of a wire conductor on or in a substrate layer by means of ultrasonic embedding using a sonotrode, according to the prior art; and

FIG. 7B (compare FIG. 2 of U.S. Pat. No. 6,233,818) is a cross-section view representing a wire conductor embedded on or in a substrate layer, according to the prior art.

FIG. 8 is an exploded, perspective view of a construction of a 4-ply wooden card having layers of wood veneer (sliced and rotary peeled), adhesive layers for bonding, and a wire embedded booster antenna circuit incorporated in a core substrate layer and the exposed front and rear surfaces receiving digitally deposited (graphic) artwork protected by a topcoat of varnish, according to an embodiment of the invention. A transponder chip module is shown in this figure, and may be omitted in some of the following figures, for illustrative clarity.

FIG. 9 is an exploded, perspective view of a construction of a 4-ply wooden card having layers of wood veneer (sliced and rotary peeled), adhesive layers for bonding, and a wire embedded booster antenna circuit incorporated in a core substrate layer, and the exposed front and rear surfaces laser marked (LM) with graphic elements, according to an embodiment of the invention.

FIG. 10 is an exploded, perspective view of a laminated sheet assembly (stack-up, construction) in a 3×8 format having a plurality of card body sites for production of a like plurality of smart card bodies, said laminated sheet having a front (top) exposed surface and a rear (bottom) exposed surface, said laminated sheet assembly comprising 4 wood veneer layers, 4 adhesive layers and a core substrate layer incorporating a booster antenna circuit, according to an embodiment of the invention.

FIG. 11 is an exploded, perspective view of a construction of a 5-ply wooden card having outer layers of sliced wood veneer and inner layers of adhesive coated rotary peeled wood veneer, wherein the adhesive coating functions as an agent for interlayer bonding and to accept the wire embedding of an antenna circuit, according to an embodiment of the invention.

FIG. 12A is an exploded, perspective view of a construction of a 4-ply wooden card having outer (non-stained) layers of sliced wood veneer and inner (stained) layers of rotary peeled wood veneer, adhesive layers for bonding, and a wire embedded booster antenna circuit incorporated in a core substrate layer, and the exposed front and rear surfaces laser marked with graphic elements, according to an embodiment of the invention.

FIG. 12B is an exploded, perspective view of a construction of a 4-ply wooden card having outer layers of rotary peeled wood veneer and inner layers of colored sliced wood veneer, adhesive layers for bonding, and a wire embedded booster antenna circuit incorporated in a core substrate layer, and the exposed front and rear surfaces laser marked with graphic elements, according to an embodiment of the invention.

FIG. 13A is an exploded, perspective view of a construction of a 4-ply wooden card having outer (colored or non-colored) layers of sliced wood veneer and inner (colored or non-colored) layers of rotary peeled wood veneer, wherein the wood veneer layers are prepressed before final lamination of the assembly, according to an embodiment of the invention.

FIG. 13B is an exploded, perspective view of a construction of a 4-ply wooden card having outer(prepressed) layers of rotary peeled wood veneer and inner (prepressed) layers of sliced wood veneer, according to an embodiment of the invention.

### GLOSSARY

The following abbreviations may appear in the drawings and in the description that follows:

| | | | |
|---|---|---|---|
| LSA | laminated sheet assembly | ACF | adhesive coated fleece |
| SC | smartcard | ACP | adhesive coated paper |
| SCB | card body site | ACW | adhesive coated wood |
| WTC | wooden transaction card | CBS | card body subassembly |
| TCM | transponder chip module | FS | front subassembly |
| CP | contact pads | CS | core subassembly |
| CB | card body | RS | rear subassembly |
| MA | module antenna | AFL | additional front layers |
| MO | module opening | ARL | additional rear layers |
| RF | radio frequency | BA | booster antenna (or |
| | | | booster antenna |
| SFL | sacrificial layer | | circuit (BAC)) |
| PWL | peeled wood (or wooden) layer | CF | coupling frame |
| SWL | sliced wood (or wooden) layer | IL | impregnation layer |
| IWL | intermediate wood (or wooden) | PR | primer |
| | layer | | |
| WL | wood (or wooden) layer | AW | artwork |
| WV | wood veneer | TC | topcoat |
| RL | reinforcement (or reinforcing) | LM | laser marking |
| | layer | | |
| SL | substrate layer | MS | magnetic stripe |
| AC | adhesive coating | H | hologram |
| AL | adhesive layer | HF | holographic foil |
| BL | bonding layer | MC | moisture content |

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Cards incorporating transponder chip modules are known, such as may be shown in the following patents and patent publications, incorporated by reference herein: U.S. Pat. Nos. 9,272,370; 9,390,364; 9,489,613; and US 2013/0126622.

Reference may be made to disclosures of prior patents, publications and applications. Some text and drawings from those sources may be presented herein, but may be modified, edited or commented to blend more smoothly with the disclosure of the present application.

Reference(s) may be made to links for some websites on the world wide web. The standard (https . . . , sometimes including www) prefixes may be omitted, or replaced by “internet”.

Cards incorporating wood veneer layers are known, such as may be shown in the following patents and patent publications, incorporated by reference herein: U.S. Pat. Nos. 8,579,201; 10,572,784; 10,832,115; US 2010/0033297; US 2019/0311238; US 2022/0184931; WO 96/23276; and WO 2022/112610.

As used herein, a wooden transaction card (WTC) is a type of smartcard (SC) which comprises one or more wood (or wooden) layers (WL) which may be wooden veneer layers. In some embodiments, a booster antenna (BA) may be incorporated into the construction, typically in an adhesive layer (AL) of a reinforcing layer (RL) which may comprise a substrate (or support) layer (SL) having an adhesive layer on at least one side thereof.

US 2024/0001585 (4 Jan. 2024; Swiss Wood Solutions; Chanana et al.), entitled “Densified hygroscopic materials and products made thereof”, incorporated by reference herein, discloses a method for densifying a hygroscopic material. The method is for hygroscopic material which may be a natural hygroscopic material or wood. The method comprises the steps of providing the hygroscopic material to be densified; pre-conditioning of the hygroscopic material by adjusting the moisture content of the hygroscopic material to a value within a predefined moisture range, if required; simultaneously heating and pressing the gas-tight packed hygroscopic material under predefined temperature and pressure conditions, whereby the moisture content of the hygroscopic material is kept constant; and obtaining a densified material.

Some of the embodiments of the invention described herein may comprise two or more wooden (veneer) layers (WL) and may also comprise two or more reinforcement layers (RL).

A typical reinforcement layer (RL) may comprise a substrate layer (SL) having adhesive or an adhesive layers (AL) disposed on both sides or surfaces (i.e., front or top, and rear or bottom) thereof.

The wooden layers (WL) and reinforcement layers (RL) may be arranged in a “stack-up” construction of a smart card body (CB) or, more specifically in subassemblies of the card body, such as a front subassembly (FS), a rear subassembly (RS), and a core subassembly (CS) disposed between the front and rear subassemblies.

As used herein, the terms “front” and “rear” may appear in some of the figures, and refer to the top (or front face) and bottom (or rear face), as viewed in the figures, of the resulting smart card (SC) which may be a wooden transaction card (WTC) or variation thereof (such as a hybrid metal wood transaction card), or the like.

Terms such as “front”, “top”, “frontmost”, “topmost” and the like may be used to distinguish similar (such as wooden) layers from one another in descriptions of the constructions presented herein. Similarly, terms such as “rear”, “bottom”, and the like may be used to distinguish similar (such as reinforcement) layers from one another. Also, it should be understood that the layers described herein are generally planar, having length and width dimensions substantially equal to the overall dimensions of the card body (CB), the ISO standard for which is 85.60 mm width (long dimension), 53.98 mm height (short dimension). References may be made to front (or top) surfaces (or sides) of layers (such as WL, RL, SL, AL, ML, DMC, CML) consistent with how these surfaces appear in relevant figures. The ISO standard for card thickness is 0.76 mm (760 μm) thick. The individual layers typically have thicknesses which are a fraction of that, such as approximately 100 μm.

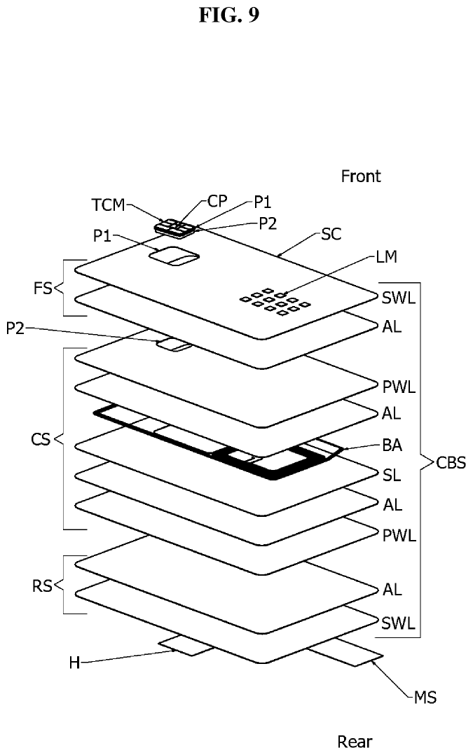

In some of the embodiments described herein, the frontmost layer of the front subassembly (FS) of the card body (CB) may be a sliced wooden layer (SWL), see for example FIGS. 9, 10, 11, 12A, 13A.

In some of the embodiments described herein, the frontmost layer of the front subassembly (FS) of the card body (CB) may be a peeled wooden layer (PWL) as shown for example in FIGs, 12B 13B.

The three subassemblies (FS, CS, RS) may be laminated together to form a card body subassembly (CBS). Additional front layers (AFL) may be disposed on a front side of the laminated card body subassembly (CBS). A chip module or transponder chip module (TCM) may be disposed in a module opening (MO) extending into the card body (CB) from a front surface thereof through the additional front layers (AFL) and further into some of the layers of the core subassembly (CS), resulting in contact pads (CP) of the chip module or transponder chip module (TCM) being exposed on the front surface (obverse) of the card. Additional rear layers (ARL) may be disposed on a rear side of the laminated card body subassembly (CBS). A magnetic stripe (MS) may be disposed on the rear surface of the card.

In addition to the above, other elements may be incorporated in the stack-up construction of the card. For example, a booster antenna (BA) or booster antenna circuit (BAC) may be incorporated in the construction. See, for example, FIGS. 8, 9, 10, 11, 12A, 12B, 13A, 13B.

Pressure and heat are used to laminate the various constructions with their layers and elements together. Typically, the laminating process will result in compressing the stack-up construction from an initial thickness of 1300-1400 μm, to a desired ISO-compliant thickness of 760-800 μm. In some embodiments, front and rear wooden layers may be thinned, such as by sanding, after lamination to achieve the desired ISO-compliant thickness.

It should be understood that all dimensions (such as thickness and weight) and process parameters (such as pressure, temperature and dwell time) may be considered to be approximate (may include dimensions and parameters ranging+/−5 or 10% from a stated “nominal” value), unless indicated otherwise. Sometimes, ranges may be specified, such as (for example):
The thickness of the wooden (veneer) layers (WL, PWL, SWL) having a nominal preconditioned (drying process at the mill) thickness of 150 μm may be between 125 μm and 175 μm.
The thickness of the wooden (veneer) layers WL, SWL) having a nominal preconditioned (drying process at the mill) thickness of 550 μm may be between 525 μm and 575 μm.
The thickness of the adhesive layers (AL), nominally 25 μm, may range from 20-30 μm, prior to lamination.
The thickness of a substrate layer (SL, nominally 100 μm, may range from 90-110 μm.
The thickness of a stack-up of layers, before press lamination, nominally 1350 μm, may range from 1300-1400 μm.
The thickness of a stack-up of layers, before press lamination, nominally 1700 μm, may range from 1650-1750 μm.
The thickness of a card body subassembly, before press lamination, nominally 1650 μm, may range from 1600-1700 μm.
A lamination pressure applied to the stack-up, nominally of 500 N/cm², may range from 450-550 N/cm².
A lamination pressure applied to the stack-up, nominally of 850 N/cm², may range from 825-875 N/cm².
A lamination pressure applied to the stack-up, nominally of 900 N/cm², may range from 850-950 N/cm².
A lamination pressure applied to the stack-up, nominally 1250 N/cm², may be between 1200 to 1300 N/cm².
After press lamination, the thickness of the card body (CB), nominally 800 μm, may range from 760-800 μm, after lamination.

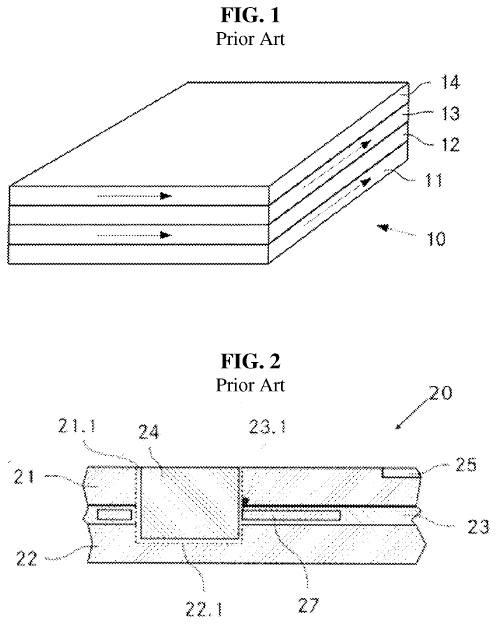

FIG. 1 shows a laminated structure 10 which was produced by laminating four rectangular layers of densified wood veneer 11, 12, 13, 14. The structure was formed by bonding adjacent layers 11, 12, 13, 14 together with an adhesive, e.g. a polyurethane or any other adhesive.

As indicated by the arrows in FIG. 1, the wood grain direction of adjacent layers are perpendicular to each other. This gives a highly stable laminated structure with reduced flexibility. A wooden electronic card 20 as shown in FIG. 1 and having a size of 85.5 mm×54 mm×0.8 mm was produced by according to the following process:

An upper layer 21 (frontside of the card) and a lower layer 22 (backside of the card) each consisting of a densified wood veneer were provided and cut to a size of about 90 mm×60 mm with a computerized numerical control laser engraving and cutting machine (CNCL).

A middle layer 23 consisting of a support sheet (densified veneer) with an integrated/glued electromagnetic coil 27 was provided and cut to the same size as the upper and lower layers 21, 22.

In the upper layer 21 and the middle layer 23, using the CNCL, a rectangular opening 21.1, 23.1 for an integrated circuit chip 24 with electrical surface contacts 24.1 was cut. In the lower layer 22, a rectangular recess 22.1 (deepness of approximately 0.1 mm) was engraved to provide additional place for the chip 24.

A polyurethane foil or gelatin/protein-glue sheet (40-80 g/m²; area density depending on type of wood) was applied on the inside of the upper layer 21 and the lower layer 22 as an adhesive foil. Each layer 21, 22, 23 as well as the chip 24 were carefully positioned and assembled to obtain the basic structure of the card 20. The assembled basic structure was then placed in a vacuum bag, which was then evacuated in order to apply a pressure of approximately 1 MPa. The vacuum was maintained for 6 hours.

The electronic functionality, e.g. a contactless payment function, of the card was tested before the outer surface of the upper layer 21 was engraved using the CNCL. Thereby, a first engraving 25 consisting of a logo and a second engraving 26 consisting of characters and numbers were produced. Thereby, the moving speed and laser power were adjusted in order to avoid burning of the wooden surface. Further engravings were provided on the outer surface of the lower layer 22.

Thereafter, the final shape of the card was cut using the CNCL (using a different set of moving speed and laser power). Subsequently, the engravings 25, 26 were colored using a silver color pen. The drying time was about 2 hours. Then the front side 21 as well as the backside 22 of the card 20 were sanded and polished with by using sanding papers with gradually increasing fineness (180, 240, 320 and 600 grit size). After testing the card functionality, e.g. contactless and contact payment function, the card was ready for use.

The US application 2024/0001585 (Swiss Wood Solutions) is based on the following two previously filed European applications.
PCT/EP2021/083617 filed 30 Nov. 2021, published as WO 2022/112610 (2 Jun. 2022)
PCT/EP2020/083947 filed 30 Nov. 2020, published as WO 2022/111835 (2 Jun. 2022)

References cited by the PCT against Swiss Wood Solutions' PCT application(s):

| | | |
|---|---|---|
| JP 3136048 B2 | 2001 Feb. 19 | Eidai Co Ltd |

F. Eng et al., “Possibility of Improving the Properties of Mahang
Wood Through Phenolic Compreg Technique” 2014 Feb. 1

| | | |
|---|---|---|
| CN 108582377 | 2018 Sep. 28 | Univ South China Agricult |
| CA 2103882 | 1995 Feb. 12 | Prihoda |
| US 2016/0193868 | 2016 Jul. 7 | Espe |
| CN 111185977 | 2020 May 22 | Zhejiang Academy Forestry |
| U.S. Pat. No. 10,572,784 | 2020 Feb. 25 | Kushner |
| CN 107614221 | 2018 Jan. 19 | Palmholz Co Ltd |
| CN 108773237 | 2018 Nov. 9 | Dongguan Wantusiriu |
| US 2010/033297 | 2010 Feb. 11 | Patovirta |

FIG. 2 shows a card 20 with the chip 24 and the electromagnetic coil 27 fully embedded within the card body. Cards with such a structure turned out to be fully functional as required by standard ISO/IEC 7810:2019.

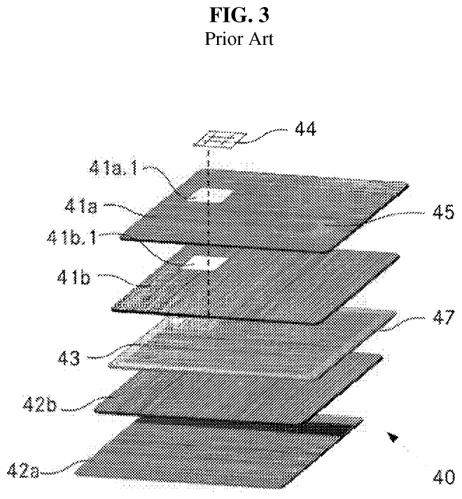

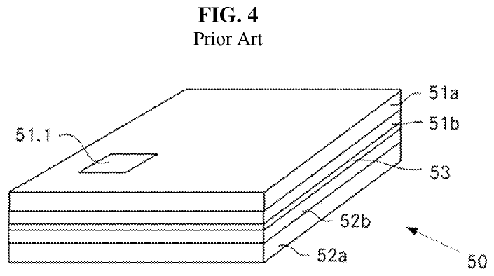

FIG. 3 shows an exploded assembly drawing of another card 40 with electronic functionality. Card 40 comprises an upper part consisting of two laminated densified wood veneers 41a, 41b. The wood grain direction of the densified wood veneers 41a, 41b are perpendicular to each other. Both wood veneers 41a, 41b comprise a rectangular opening 41a.1, 41b.1 for receiving an integrated circuit chip 44. The outermost wood veneer 41a furthermore carries a printed logo 47 on the outer side.

A lower part of card 40 consists of two further laminated densified wood veneers 42a, 42b. Also in this case, the wood grain direction of the densified wood veneers 42a, 42b are perpendicular to each other.

In the middle of the card, there is an inlay 43 consisting of a wood veneer carrying an electromagnetic antenna 47 with contacts for chip 44. All of the layers 41a, 41b, 43, 42a, 43b of the card are adhesively bonded together in the final product.

Card 40 consists of five densified wood veneers whereby the wood grain direction of adjacent veneers are perpendicular to each other. Therefore, card 40 is especially robust from a mechanical point of view.

FIG. 4 shows a card with electronic functionality. FIG. 4 shows a perspective view of another card 50 with electronic functionality. The card 50 is a laminated structure made from five layers of a hygroscopic material. Specifically, it comprises two top layers 51a, 52a of wood veneer, two thin mid layers 51b, 52b of wood veneer and an inlay layer 53 comprising a metal antenna 57 with contacts for a chip on a paper.

A thickness of each of the two top sheets 51a, 52a is for example 0.6 mm whereas a thickness of the two thin mid sheets 51b, 52b is for example 0.2 mm. The inlay layer 53 has for example a thickness of 0.1 mm.

Similar to card 40, card 50 comprises an opening or recess 51.1, respectively, for receiving an integrated circuit chip (not shown in FIG. 4). A symmetric setup as shown in FIG. 4 is suitable for direct connection or soldering, respectively, (“TE-Connect®”), i.e. conductive glue, “Asymmetric conductive foil (ACF)”, i.e. conductive gluing tape and “Coil-on-Module”, i.e. that belongs to group of Inductive-Coupling-chip-coupling technology. Also for the embedding of chip-coil-plug (the dual-interface chip and the antenna are on the same module/plug), the symmetric setup is suitable, as the card will not warp or deform beyond the requirements as defined in the ISO 7816.

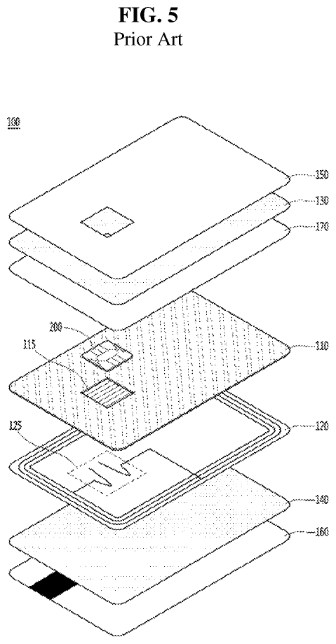

FIG. 5 shows a wooden card and method of manufacturing the card, the method comprising the steps of: processing a wood sheet; stacking the wood sheet on an inlay sheet including an antenna that will be connected to a COB chip; milling an area corresponding to the chip on the wood sheet, and forming a residual layer of a thickness smaller than that of the wood sheet; exposing end portions of the antenna passing through the residual layer from the inlay sheet located under the residual layer of the wooden sheet; and electrically connecting the chip and the end portions of the antenna.

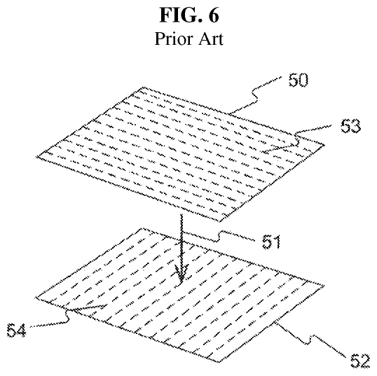

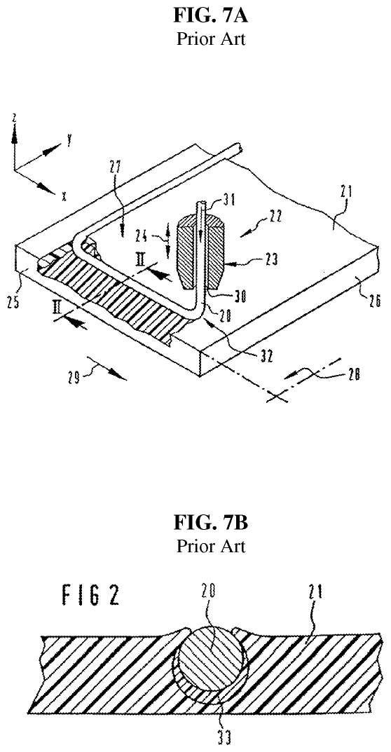

FIG. 6 shows an exemplary wood-on-wood inlay assembly process that may be performed at step 1006. In this exemplary embodiment, a first softened and thinned wood layer 50 of a first wood material is laminated to (as indicated by an arrow 51) a second softened and thinned wood layer 52 to form a laminated stack (i.e., a wood inlay stack). Again, the first and second wood materials herein may be the same or different, thus providing a flexibility in selecting wood materials for forming a wood inlay to meet various card performance and appearance criteria.

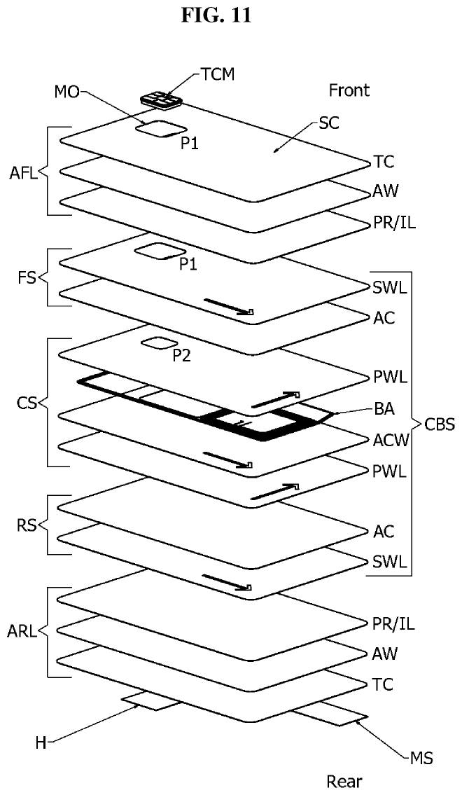

In some embodiments, at step 1006, a grain direction of a first wood layer may be rotated to a certain angular degree (e.g., 90 degrees) with respect to a grain direction of a second wood veneer layer that acts as a backing layer for the first wood veneer layer. Rotating the wood layers with respect to each other may increase inlay performance by improving the stiffness strength, resilience, and overall durability, even under stresses cause by multi-directional bending. In the exemplary embodiment shown in FIG. 11, a horizontal grain direction (as indicated by 53) of first wood layer 50 is rotated to 90 degrees with respect to a vertical grain direction (as indicated by 54) of second wood layer 52. That is, first wood layer 50 and second wood layer 52 are stacked with their grain structure perpendicular to each other. Herein, a horizontal grain direction indicates that the grain pattern may parallel the length of the card, while a vertical grain direction indicates that the grain pattern may parallel the width of the card.

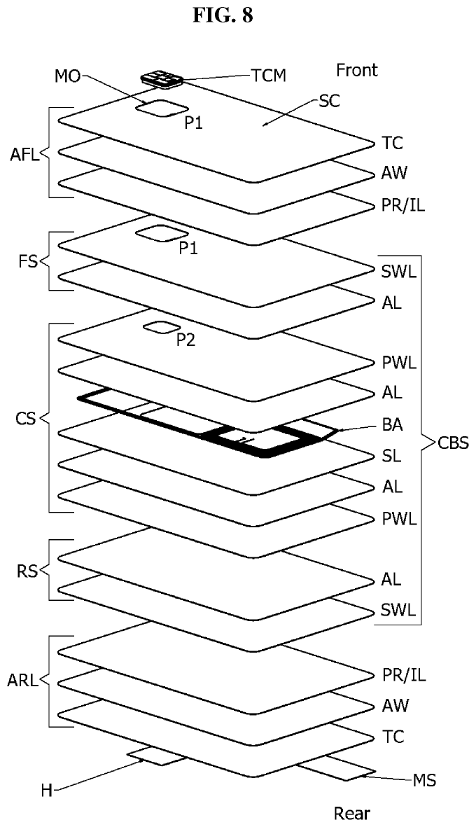

FIG. 7A shows the wiring of a wire conductor 20 on a substrate 21 by means of a wiring device 22 with a wire guide 23 which is subjected to the action of ultrasound.

The wiring device 22 represented in FIG. 7A is designed to be capable of being displaced along three axes and is subjected to the action of ultrasound which stimulates the wire guide 23 to execute oscillating transverse movements (arrow 24), which in the example represented in FIG. 7A are aligned perpendicular to a wiring plane 28 spanned by lateral edges 25, 26 of a substrate surface 27.

For the purpose of wiring, the wire conductor 20 is moved out of a wire-guide nozzle 30 while executing a continuous advancing movement in the direction of the arrow 29, whereby at the same time the wire guide 23 executes a wiring movement 29 which extends parallel to the wiring plane 28 and which in FIG. 7A can be retraced from the course of the wire-conductor section already wired on the substrate 21. On this wiring movement, which extends in the region of the front lateral edge 25 in the direction of the arrow 29, the oscillating transverse movement 24 is superimposed. This results in an impinging or impacting of the wire-guide nozzle 30 on the wire conductor 20 which is repeated in rapid succession corresponding to the ultrasonic frequency, leading to a compression and/or displacement of the substrate material in the region of a contact point 32.

FIG. 7B corresponds roughly to the course of the line of intersection II-II indicated in FIG. 7A, and shows the embedded arrangement of the wire conductor 20 in the substrate 21. The substrate represented here is a PVC sheet, whereby for the purpose of embedding the wire conductor 20 the wire conductor is subjected via the wiring device 22 to, for example, an ultrasonic power output of 50 W and an ultrasonic frequency of 40 kHz. The contact force with which the wire-guide nozzle 30 is caused to abut the substrate surface 27 may, in the case of the aforementioned substrate material, lie in the range between 100 and 500 N.

As is evident from the representation according to FIG. 7B, in a test which was carried out by adjusting the aforementioned parameters an embedding of the wire conductor 20 into the substrate 21 was obtained substantially by virtue of a compression of the substrate material in a compression region 33 of the substrate material which here is crescent-shaped.

The wiring principle represented in FIG. 7A can be universally employed. For instance, departing from the use elucidated in detail below in connection with the manufacture of a card module, the principle may also find application in connection with the wiring of wire coils in plastic casings, for instance in order to form an aerial for a cordless telephone (mobile phone) or in order to form a measuring coil of a sensor.

### Some Terminology

Some of the following terms may be used or referred to, herein.

### Sacrificial Layer (SFL)

A sacrificial layer is a temporary material or film that is intentionally used and then removed to enable the creation of a final surface structure on the front and rear face of a laminated sheet assembly (LSA) having an array of card body sites comprising outer layers of wood veneer (WL). A sacrificial layer is arranged between the top and bottom lamination plate, sandwiching the sheet assembly in preparation for press lamination. During compression or densification of the sheet assembly in a lamination press, internal layers of adhesive melt and seep through the pores of the wood veneers, with the sacrificial layer (on each side of the assembly) acting as a back-stop to the flow of adhesive resin. The sacrificial layer also prevents adhesive accumulating on the surface of the (glossy) lamination plates (platens). Post lamination and removal of the sacrificial layers, the front and rear (exposed) surfaces may have a polymeric finish with a surface roughness Ra<1 μm. This polymeric finish may be laser engravable. The sacrificial layer may be a polyethylene terephthalate (PET) release film or a film mixture of polyethylene terephthalate, acrylated epoxy mixture and diatomaceous earth. The release film may impart a surface roughness to the adhesive filled pores of the wood veneer. The release film may be replaced by a (Teflon, PTFE) coated lamination plate.

### Subassembly Tacking

After alignment and collating of the layers forming the stack-up assembly in preparation for press lamination, the bundle is joined or fastened together using temporary staples.

### Substrate Layer (SL) for Ultrasonic Wire Embedding

Wire embedding is a technique for integrating a conductive wire (insulated or uninsulated) onto or into a substrate layer in forming an electrical circuit such as a configuration of antenna elements, also known as a booster antenna circuit (BAC). The process involves pressing or fusing the conductive wire onto or into the surface or into pre-defined channels. The substrate layer (SL) may be a deformable material such as adhesive, paper, plastic or pulp (including polymers and composites). The substrate layer (SL) may have a coating of adhesive to enhance adhesion. The wire conductor may be countersunk into the material using an ultrasonic embedding tool (aka a sonotrode). The wire conductor may be a self-bonding insulated copper wire remaining fixed in position at a certain depth after scribing under pressure and friction (temperature) into the material. The ultrasonic energy deforms the substrate's surface, creating a channel to securely hold the wire, requiring a material that can be deformed without cracking or losing its structural integrity. The substrate layer (SL) incorporating an array of booster antenna circuits (BAC) may be replaced by an array of plated copper antennas on an acrylic carrier or aluminum antennas on a PET carrier.

### ISO Compliant Thickness of a Laminated Sheet Assembly or a Singulated Card Body

The lamination parameters determine the degree of shrinkage of the complete stack-up assembly during press lamination. However, the resultant thickness is also determined by the thickness and material composition of the interlayers forming the assembly.

### Choice of Lamination Parameters

For a given stack-up assembly of material layers (e.g. wood species, adhesive layers, reinforcement layers, core substrate layer, antenna structure and footprint, etc.), the choice of lamination parameters determines the shrinkage of the laminated assembly and the stiffness/bendability, breakpoint and weight of the final card body. Said lamination parameters also determine the force required to delaminate or separate the material layers. The strength of the card body along its lengthwise and crosswise directions is also determined by the lamination parameters and the orientation of the grain direction in each of the wood veneer and reinforcement layers.

### Moisture Content

The moisture content (MC) of wood veneers typically ranges from 8% to 12% after drying at the mill (considered “well-seasoned timber”), with some variations between manufacturers and depending on the intended application. The application of hotel key cards usually requires lower moisture levels (around 6-9%, considered “dried-out timber”). Achieving a uniform and controlled MC is crucial, as it affects the veneer's mechanical properties, bonding strength, and overall quality.

Conversely, a higher moisture content MC of the wood veneer layers (WL) facilitates thickness uniformity and stability during and after lamination (under induced pressure and temperature), with the moisture chemically interacting with the molten thermoplastic adhesive resin flowing through the pores of the wood veneers. High moisture content improves the interlayer bonding, and avoids thickness expansion (spring-back) after press lamination.

Storage conditions at 60% relative humidity at room temperature increase (slightly) the moisture content of the delivered wood veneers from the mill before press lamination.

The teachings of US 2024/0001585 are not applicable as a pre-conditioning cycle (to remove moisture at a temperature of 50-100° C. and a pressure of 0 to 2 MPa (0-200 N/cm²)) is not desirable.

### Plasma Surface Treatment

Plasma treatment, also known as plasma cleaning, plasma etching, plasma surface modification or activation, involves striking the surface with high energy electrons and ions. This modifies the physical and chemical structure of the very top (exposed) layer and changes surface wettability and functionalization. With plasma surface activation, the material's surface is much more conducive to adhesion for bonding, digital printing, screen printing, coating, and the like. Plasma treatment becomes an indispensable tool for processing low surface energy solids such as plasticized or polymeric surfaces including densified adhesive induced surfaces like laminated wood veneers. Reference is made to internet.plasmatreat.com/de/

### Lamination Parameters for Compressing or Densifying a Stack of Wood Veneers

The teachings of US 2024/0001585 emphasize a three-step approach to the lamination process in densifying a wooden card structure: (i) a pre-conditioning cycle (first temperature: 50-100° C.—first pressure: 0 to 2 MPa (0-200 N/cm²)—dwell time: 1 min—10 hours), (ii) press lamination cycle (second temperature (same as first temperature): 50-100° C.—second pressure: 9-50 MPa (900-5000 N/cm²)—dwell time: 1-45 min and increasing the second temperature: 100-220°—keeping the second pressure: 9-50 MPa (900-5000 N/cm²)—dwell time: 1-120 min), and (iii) a cooling cycle (reducing to room temperature: 22° C. and reducing to ambient pressure).

According to the present invention, a pre-conditioning cycle to remove moisture content after drying the wood veneers at the mill (with a resultant moisture content in the range of 6-9%, ideally 8%) is not considered desirable. The selection of material layers in the stack-up assembly and their thickness in combination with the choice of lamination parameters determines the level of shrinkage, final thickness and ultimately the weight of the compressed or densified material layers. Three classification ranges of lamination parameters have been defined.

### Medium Pressure

A stack of wood veneer layers, adhesive layers and a core substrate layer in forming a card body structure may be press laminated at a pressure in the range of 1.5-2.0 MPa (150-200 N/cm²) at a temperature of approximately 140-150° C. for a dwell time of 15 to 30 minutes, with the post lamination thickness of the assembly achieving ISO thickness compliance without the process of sanding-back the laminated assembly, but with a limitation on the thickness of the individual material layers forming the stack-up assembly and a reduced weight of the card body compared to laminating at high or very high pressure using thicker materials;

### High Pressure

The press lamination may be performed in a single, continuous lamination process (linear, gradual (curved) or exponential) using a pressure between 2.0-8.5 MPa (200 N/cm² and 850 N/cm²) at a temperature between 135° C. and 150° C. for a dwell time between 30 and 50 minutes followed by a cooling cycle to ambient pressure and temperature, allowing for thicker individual material layers forming the stack-up assembly to be applied and achieving an increase in the weight of the card body; and

### Very High Pressure

A densification pressure of 9-50 MPa (900-5000 N/cm²) as proposed by the teachings in US 2024/0001585 defines a pressure range which is not applicable in the production of wooden smartcards.

The press lamination may be performed in a single, continuous lamination process (linear, gradual (curved) or exponential) using a (high) pressure of 8.5 (850 N/cm²) at a temperature between 135° C. and 150° C. for a dwell time between 30 and 50 minutes followed by a cooling cycle to ambient pressure and temperature, allowing for substantially thicker individual material layers forming the stack-up assembly to be applied and achieving a significantly higher increase in the weight of the final card body.

Below 1.5 MPa (150 N/cm²), the pressure may be considered “low pressure”, often referred to as “kiss lamination pressure”.

Above 12.5 MPa (1250 N/cm²), in the range of 12.5-50 MPa (1250-5000 N/cm²), the pressure may be considered as “ultra-high pressure”.

Stated differently, for a given stack-up construction of material layers in forming a card body structure having a thickness before press lamination of 1700 μm (front SWL (Maple: 550 μm)+AL (25 μm)+PWL (Maple: 200 μm)+AL (25 μm)+core SL (100 μm) with BAC+AL (25 μm)+PWL (Maple: 200 μm)+AL (25 μm)+rear SWL (Maple: 550 μm), the following pressure ranges define a certain post lamination thickness of the assembly:
a single, continuous lamination cycle at Medium Pressure (2.0 MPa (200 N/cm²) at a temperature of approximately 150° C. (between 135° C. and 165° C., depending on the type of adhesive) for a dwell time of 15 or 30 minutes), the post lamination thickness of the stack-up assembly is approximately: 1200 μm, representing a shrinkage of 29%, and thus requiring a reduction in the thickness of the individual wood veneer layers forming the stack-up assembly to reach an ISO card body thickness of 760-800 μm, with the consequences of a reduction in the card body weight and its mechanical strength or robustness;
a single, continuous lamination cycle at High Pressure (8.5 MPa (850 N/cm²) at a temperature of approximately 150° C. (between 135° C. and 165° C., depending on the type of adhesive) for a dwell time of 30 or 50 minutes), the post lamination thickness of the stack-up assembly is approximately: 810 μm for both durations of lamination, representing a shrinkage of 52-53% with the color of the surface finish on both sides of the card body from the internal melting of the adhesive varies with the duration of lamination, brighter at 30 minutes and slightly darker at 50 minutes;
a single, continuous lamination cycle at Very High Pressure (12.5 MPa (1250 N/cm²) at a temperature of approximately 150° C. (between 135° C. and 165° C., depending on the type of adhesive) for a dwell time of 30 or 50 minutes), the post lamination thickness of the stack-up assembly is also approximately: 810 μm, representing a shrinkage of 52-53%, but with a noticeable difference in the color of the surface finish on both sides of the card body which is attributable to the higher pressure and duration of lamination resulting in a color from light brown to dark brown.

The above results demonstrate that for a given stack-up construction, such as described above, with an initial thickness of approximately 1700 μm, the post lamination thickness of the assembly, in applying a pressure of 850 N/cm² or 1250 N/cm² at a temperature of approximately 150° C. (between 135° C. and 165° C., depending on the type of adhesive) for a dwell time of 30 minutes is approximately 760-800 μm (representing a shrinkage of 52-53%) at both pressure levels, without a preconditioning cycle to remove moisture. Therefore, a press lamination pressure of 850 N/cm² at a temperature of approximately 150° C. (between 135° C. and 165° C., depending on the type of adhesive) for the abovementioned stack-up construction represents a threshold point in the compression process, with a dwell time of 30 or 50 minutes regulating the color of the surface finish on both sides of the card body.

Note in applying a pressure of approximately 850 N/cm² at a temperature of approximately 150° C. (between 135° C. and 165° C., depending on the type of adhesive) for a dwell time of approximately 15 minutes for the same stack-up construction, the post lamination thickness is approximately 860 μm representing a shrinkage of 49%, requiring a reduction in the thickness of material layers to be ISO conform or increasing the dwell time to approximately 30 minutes.

The lamination parameters, in particular the applied pressure and dwell time may be further optimized by reducing the thickness of the individual layers of wood veneer, such as the front and rear face sliced wood veneer having a thickness of 550 μm which could be reduced to 525 μm, or reducing the thickness of intermediate rotary peeled wood veneer layers from 200 μm to 150 μm, and interchanging the hard wood species from maple to birch to achieve a different compression. However, a reduction in the thickness of the material layers has an impact on the weight of the card body.

The dwell time determines the production capacity and its time reduction is essential for an increased production throughput. The number of stacked assemblies between lamination plates in a daylight (space between heated platens of the laminator) of a lamination press determines the duration of the dwell time.

### Lamination Presses

A lamination press, used for bonding layers of wood and adhesive through heat and pressure, consists of a robust structural frame, hydraulic cylinders for pressure application, and heating/cooling platens to activate adhesive layers and compress the material layers. Key components include heated press plates, precise temperature controls, a hydraulic unit, vacuum systems (optional), and loading/unloading mechanisms to ensure consistent bonding.

The area between heating/cooling platens in a lamination press is referred to as a daylight. Assemblies are usually placed between glossy or matt lamination plates, and loaded into a daylight (between platens).

Using cassettes, multiple assemblies, stacked between lamination plates, can be laminated simultaneously. Single assemblies can be laminated between lamination plates with a shorter lamination cycle.

Although not shown, lamination presses as well as processes for performing lamination generally (i.e., applying heat and pressure), are well known. This application presents some specific (inventive) laminating parameters which can be performed to produce the (inventive) laminated structures disclosed herein using conventional lamination presses.

### Adhesive Coated Wood

Rotary peeled or sliced wood veneer layers may be coated on one or both sides with a thermoplastic adhesive such as polyvinyl acetate (PVA, PVAc), commonly known as wood glue. A wire antenna may be scribed into a PVAc coated wood veneer in forming a booster antenna circuit (BAC).

### Curtain Coating

Curtain coating is a non-contact process for applying a uniform, pre-metered layer of adhesive onto a moving substrate by guiding the substrate through a free-falling, stable curtain of the coating resin. This method offers precise, consistent coating thickness and excellent coverage, making it ideal for products like specialty papers, fleece and wood veneers.

### Lamination Cycle Time

Lamination cassettes are typically used in the production of smartcards and may accept up to 10 collated assemblies (each assembly being a stack-up of multiple layers in a production format, placed between lamination plates) and held in a fixed position to ensure accurate alignment. The loaded cassette may be placed in a daylight of a lamination press, and for a given temperature and pressure, the dwell time may be 30 minutes. A lamination press may have multiple daylights.

Alternatively, a single collated assembly may be placed between lamination plates and for a given temperature and pressure, the dwell time may be only 6 minutes. Depending on the size of the working table in the press and the lamination plates, several collated assemblies may be placed side by side, to increase the throughput.

### Ageing Effect

The lamination of a stack-up assembly comprising outer layers of sliced wood veneer (SWL: 550 μm and inner layers of rotary peeled wood veneer (PWL: 200 μm) causes the internal bonding layers of adhesive to seep through the pores of the wood veneer layers to the outermost front and rear layers of the assembly leaving a surface finish with a glossy sheen or matt finish. This exposure to pressure and temperature for a defined duration causes the wood glue to yellow and to change the color of the wood veneer. For a given temperature (e.g., 150° C.) and application of pressure (e.g. 850 N/cm² or 1250 N/cm²) over a dwell time of 30 to 50 minutes, the color of the wood veneer can be changed from a bright to a dark brown, as if the wood veneer layers had undergone a process of accelerated ageing.

### Lignin

Lignin is one of the three main constituents of wood along with cellulose and hemicellulose. It is the second most abundant biopolymer and most abundant natural aromatic compound. One of its most promising applications is related to the fabrication of thermosetting materials such as phenol/formaldehyde resins, polyurethanes, epoxies, and thiol-ene resins.

### Chemical Reaction During Press Lamination

A chemical reaction under the application of temperature and pressure from the flow of melting adhesive, lignin and moisture resulting in a change of color of the adhesive (yellowing) or darkening of the wood fibers.

A chemical reaction under the application of temperature and pressure from the flow of melting adhesive, lignin and moisture may result in a change of color of the adhesive (yellowing) or darkening of the wood fibers. Also, colored wood veneers (dyed, pigmented, stained, etc.) mixes with the flow of adhesive resin in changing the color of the card body. Gradual coloring of the wood layers is feasible, resulting in color contrasting of the layers of wood veneer in the stack-up assembly.

### Dyed Wood Veneers

Wood veneer dyeing technology involves immersion-based methods, often using pressurized tanks to force a dye solution deep into the wood. These processes, which can also be enhanced by technologies like ultrasound, aim for uniform color penetration throughout the veneer's thickness, unlike surface-only stains. Key steps include dye absorption under pressure or vacuum, followed by washing and drying.

Wood veneers in a variety of colors may be used to create aesthetic effects in the construction of wooden transaction cards. Typically, wood veneers with a thickness greater than 300 μm can be dyed.

FIG. 8 shows a construction of a 4-ply wooden card having layers of wood veneer (sliced (SWL) and rotary peeled (PWL)), adhesive layers (AL) for bonding, and a wire embedded booster antenna circuit (BAC) incorporated in a core substrate layer (SL) and the exposed front and rear surfaces receiving digitally deposited (graphic) artwork (AW) protected by a topcoat (TC) of varnish. A transponder chip module (TCM) is shown in this figure, and may be omitted in some of the following figures, for illustrative clarity.

FIG. 8: Architecture of a 4-ply Wooden Transaction Card (WTC) with a Wire Embedded Booster Antenna Circuit (BAC)

The layers and process steps in the stack-up construction of the wooden transaction card (WTC/SC):
CM/TCM 6 or 8 pin faceplate transponder chip module (TCM) with a module antenna (MA) for inductive coupling with the coupler coil (CC) of an in-card booster antenna (BA) residing in a module opening (MO), or
   the 6 or 8 pin faceplate chip module (CM) may be galvanically connected to an in-card booster antenna (BA);
MA Module antenna (MA) of the transponder chip module (TCM) having for example 15 turns for inductive coupling, or
   the chip module (CM) having bond or termination pads on its face-downside for a TeConnect interconnection to the booster antenna (BA);
MO Module opening (MO) in the form of a stepped cavity (P₁ and P₂) to accept the insertion or implanting of the transponder chip module (TCM) or chip module (CM);
LM Laser marking of personalization data to the topcoat (TC) of the upward facing sliced wood (or wooden) layer (SWL) of the front single-ply wood veneer subassembly (FS)—not shown;

### AFL

TC Laser engravable topcoat (TC), sprayed-on, roller coated or silk screen printed, in the form of a water-based self-sealer or a varnish to protect the underlying graphic artwork or laser etched features;
AW Artwork—digitally deposited UV ink applied to the primed surface of the top sliced wood layer (SWL);
PR/IL Primer as an adhesion promoter for the deposition of digital ink and to function as impregnation layer (waterproofing);
   Note that the primer may be the same substance as the topcoat.
   Alternatively, the exposed wood surface after press lamination may be plasma activated to enhance the adhesion of digital ink and the subsequent application of the topcoat (TC).

### FS

Front Single-Ply Wood Veneer Subassembly (FS) bonded to the Core Subassembly (CS) using an Adhesive Layer (AL):
SWL Top sliced wood layer (SWL: upward facing side) of the front single-ply subassembly (FS) comprising a sliced wood veneer layer orientated in a horizontal grain direction (lengthwise) having an initial thickness of 550 μm; Wood species: maple
AL Adhesive layer (front) in the form of a dry film adhesive for bonding having a thickness of 25 μm;

### CS

Core Wood Veneer Subassembly (CS)—2-ply Subassembly
PWL Intermediate wood layer (Upper PWL or IWL) of the core subassembly (CS) comprising a micro thin wood veneer (rotary peeled) orientated in a vertical grain direction (crosswise) having a thickness of 200 μm;
   Wood species: maple or birch
AL Adhesive layer in the form of a dry film adhesive (thermoplastic) for interlayer bonding having a thickness of 25 μm;
BA An insulated wire conductor (Ø: 80 μm or 112 μm) embedded into the substrate layer (SL) acting as a reinforcement layer (RL), in forming a booster antenna circuit (BAC) with a 10 turn coupler coil (CC), a 3-4 turn perimeter coil (aka communication coil) and a 4-8 turn extension coil;
SL Substrate layer having a thickness of 90-110 (ideally 100 μm), comprising a substrate of paper, plastic or pulp (including polymers and composites);
AL Adhesive layer in the form of a dry film adhesive (thermoplastic) for interlayer bonding having a thickness of 25 μm;
PWL Intermediate wood layer (Lower PWL or IWL) comprising a micro thin wood layer (WL) orientated in a horizontal or vertical grain (lengthwise or crosswise) direction having a thickness of 200 μm;
   Wood species: maple or birch

### RS

Rear Single-Ply Wood Veneer Subassembly (RS) bonded together using an Adhesive Layer (AL):
AL Adhesive layer (rear) in the form of a dry film adhesive for bonding having a thickness of 25 μm;
SWL Bottom sliced wood layer (SWL) of the rear single-ply subassembly (RS) comprising a sliced wood veneer layer orientated in a horizontal grain direction (lengthwise) having an initial thickness of 550 μm; Wood species: maple

### ARL

PR/IL Primer as an adhesion promoter for the deposition of digital ink and to function as impregnation layer (waterproofing);
Note that the primer may be the same substance as the topcoat.
Alternatively, the exposed wood surface after press lamination may be plasma activated to enhance the adhesion of digital ink and the subsequent application of the topcoat (TC).
AW Artwork—digitally deposited UV ink applied to the primed surface of the bottom sliced wood layer (SWL);
TC Laser engravable topcoat (TC), sprayed-on, roller coated or silk screen printed, in the form of a water-based self-sealer or a varnish to protect the underlying graphic artwork or laser etched features;
MS Magnetic stripe (2 or 3 tracks (HiCo)) applied and pressed onto or into the topcoat (TC) protecting the downward facing sliced wood layer (SWL) of the rear single-ply subassembly (RS);
LM Laser marking (LM) of personalization data to the topcoat (TC) in downward facing sliced wood layer (SWL) of the rear single-ply subassembly (RS)—not shown;

Security elements (not shown)—signature panel and payment brand hologram.

FIG. 9 is an exploded, perspective view of a construction of a 4-ply wooden card having layers of wood veneer (sliced (SWL) and rotary peeled (PWL)), adhesive layers (AL) for bonding, and a wire embedded booster antenna circuit (BAC) incorporated in a core substrate layer (SL) and the exposed front and rear surfaces laser marked (LM) with graphic elements.

FIG. 9: Architecture of a 4-ply Wooden Transaction Card (WTC) with a Wire Embedded Booster Antenna Circuit (BAC)

The layers and process steps in the stack-up construction of the wooden transaction card (WTC/SC):
CM/TCM 6 or 8 pin faceplate transponder chip module (TCM) with a module antenna (MA) for inductive coupling with the coupler coil (CC) of an in-card booster antenna (BA) residing in a module opening (MO), or
   the 6 or 8 pin faceplate chip module (CM) may be galvanically connected to an in-card booster antenna (BA);
MA Module antenna (MA) of the transponder chip module (TCM) having for example 15 turns for inductive coupling, or
   the chip module (CM) having bond or termination pads on its face-downside for a TeConnect interconnection to the booster antenna (BA);
MO Module opening (MO) in the form of a stepped cavity (P₁ and P₂) to accept the insertion or implanting of the transponder chip module (TCM) or chip module (CM);
LM Laser marking of personalization data and/or graphic elements to the upward facing sliced wood layer (SWL) of the front single-ply wood veneer subassembly (FS), post densification of the complete assembly;

### AFL

Additional Front Layers (not shown) may include a base coat as an impregnation layer for waterproofing to seal the pores of the exposed wood veneer in the form of a (screen printed) primer or varnish which simultaneously acts as an adhesion promoter for the later deposition of UV ink, and post digital printing, a topcoat in the form of a UV varnish may be applied (screen printed) to protect the underlying artwork. The topcoat of varnish may be laser engravable.

### FS

Front Single-Ply Wood Veneer Subassembly (FS) bonded to the Core Subassembly (CS) using an Adhesive Layer (AL):
SWL Top sliced wood layer (SWL: upward facing side) of the front single-ply subassembly (FS) comprising a sliced wood veneer layer orientated in a horizontal grain direction (lengthwise) having an initial thickness of 550 μm); Wood species: maple
AL Adhesive layer (front) in the form of a dry film adhesive for bonding having a thickness of 25 μm;

### CS

Core Wood Veneer Subassembly (CS)—2-ply Subassembly
PWL Intermediate wood layer (Upper PWL or IWL) of the core subassembly (CS) comprising a micro thin wood veneer (rotary peeled) orientated in a vertical grain direction (crosswise) having a thickness of 200 μm;
   Wood species: maple or birch
AL Adhesive layer in the form of a dry film adhesive (thermoplastic) for interlayer bonding having a thickness of 25 μm;
BA An insulated wire conductor (Ø: 80 μm or 112 μm) embedded into the substrate layer (SL) acting as a reinforcement layer (RL), in forming a booster antenna circuit (BAC) with a 10 turn coupler coil (CC), a 3-4 turn perimeter coil (aka communication coil) and a 4-8 turn extension coil;
SL Substrate layer having a thickness of 100 μm, comprising a substrate of paper, plastic or pulp (including polymers and composites);
AL Adhesive layer in the form of a dry film adhesive (thermoplastic) for interlayer bonding having a thickness of 25 μm;
PWL Intermediate wood layer (Lower PWL or IWL) comprising a micro thin wood layer (WL) orientated in a horizontal or vertical grain (lengthwise or crosswise) direction having a thickness of 200 μm;
   Wood species: maple or birch

### RS

Rear Single-Ply Wood Veneer Subassembly (RS) bonded together using an Adhesive Layer (AL):
AL Adhesive layer (rear) in the form of a dry film adhesive for bonding having a thickness of 25 μm;
SWL Bottom sliced wood layer (SWL) of the rear single-ply subassembly (RS) comprising a sliced wood veneer layer orientated in a horizontal grain direction (lengthwise) having an initial thickness of 550 μm; Wood species: maple

### ARL

Additional Rear Layers (not shown) may include the same elements as described in the Additional front layers (AFL), namely an impregnation layer for waterproofing and a topcoat to protect underlying printed and laser etched artwork.
MS Magnetic stripe (2 or 3 tracks (HiCo)) applied and pressed onto or into the topcoat (TC) protecting the downward facing sliced wood layer (SWL) of the rear single-ply subassembly (RS);
LM Laser marking (LM) of a QR code or personalization data to the topcoat (TC) in downward facing sliced wood layer (SWL) of the rear single-ply subassembly (RS);

Security elements (not shown)—signature panel and payment brand hologram.

FIG. 9: Description and dimensions of the individual layers forming the smartcard (SC) construction.

| | | Grain | | |
|---|---|---|---|---|
| Layers | Description | direction | Thickness | |
| SWL - FS | Sliced wood (veneer) layer (Top) - wood species: | Lengthwise | 550 | μm |
| | maple | | | |
| AL - FS | Adhesive layer for bonding | | 25 | μm |
| PWL - CS | Intermediate (rotary) peeled wood (veneer) layer | Crosswise | 200 | μm |
| | (PWL or IWL: Upper Core) - wood species: | | | |
| | maple or birch | | | |
| AL - CS | Adhesive layer in the form of a dry film adhesive | | 25 | μm |
| | (thermoplastic) for interlayer bonding | | | |
| BA - CS | Wire embedded booster antenna circuit (BAC) | | | |
| | formed in the substrate layer (SL) and completely | | | |
| | submerged (bare copper wire Ø 80 μm or Ø 112 μm | | | |
| SL - CS | Substrate layer in the form of a paper, plastic or | | 100 | μm |
| | pulp layer, alternatively adhesive coated fleece, | | | |
| | adhesive coated paper or adhesive coated wood | | | |
| | with a thickness of 150-200 μm | | | |
| AL - CS | Adhesive layer in the form of a dry film adhesive | | 25 | μm |
| | (thermoplastic) for interlayer bonding | | | |
| PWL - CS | Intermediate (rotary) peeled wood (veneer) layer | Crosswise | 200 | μm |
| | (PWL or IWL: Lower Core) - wood species: | | | |
| | maple or birch | | | |
| AL - RS | Adhesive layer for bonding | | 25 | μm |
| SWL - RS | Sliced wood (veneer) layer (Bottom) - wood | Lengthwise | 550 | μm |

species: maple

| | | | |
|---|---|---|---|
| | | Grain | |
| Layers | Description | direction | Thickness |

| | |
|---|---|
| Total thickness of the 4-ply construction with a | 1.70 mm |
| core substrate layer and 4 inner layers of | |
| adhesive before lamination: | |
| Lamination of the complete stack-up assembly in | |
| a single process step, comprising Sliced Wood | |
| Veneer Layers (SWLs), Intermediate Wood | |
| Veneer Layers (IWLs, PWLs), a core Substrate | |
| Layer (SL) incorporating a Booster Antenna | |
| Circuit (BAC) and Adhesive Layers (ALs) with a | |
| material shrinkage of 53%, resulting in a card | |
| body thickness: ~0.800 mm (760-800 μm) | |

### Impregnation/Topcoat—Laser Etched Artwork

### Additional Front Layers (AFL)

| Layers | Description | | Thickness |
|---|---|---|---|
| TC | Laser engravable topcoat (TC) - | Water-based self- | 10 μm |
| | sprayed on or screen printed, | sealer or a UV | |
| | for impregnation | Varnish | |
| AW | Laser-etched Artwork | | |

### Additional Rear Layers (ARL)

| Layers | Description | | Thickness |
|---|---|---|---|
| AW | Laser-etched Artwork | | |
| TC | Laser engravable topcoat (TC) - | Water-based self- | 10 μm |
| | sprayed on or screen printed, | sealer or a UV | |
| | for impregnation | Varnish | |

FIG. 9 shows a stack-up construction of material layers in forming a card body structure having a thickness before press lamination of 1700 μm (front subassembly (FS: SWL (Maple: 550 μm)+AL (25 μm))+core subassembly (CS: PWL (Maple: 200 μm)+an embedded BAC+AL (25 μm)+SL (100 μm)+AL (25 μm)+PWL (Maple: 200 μm))+rear subassembly (RS: AL (25 μm)+SWL (Maple: 550 μm)).

For the stack-up construction as described above with an initial thickness of 1700 μm, the post lamination thickness of the assembly, in applying a pressure of 850 N/cm² or 1250 N/cm² at a temperature of approximately 150° C. (between 135° C. and 165° C., depending on the type of adhesive) for a dwell time of approximately 30 minutes is 760-800 μm (representing a shrinkage of 52-53%) at both pressure levels, without a preconditioning cycle to remove moisture. Therefore, a press lamination pressure of approximately 850 N/cm² at a temperature of approximately 150° C. (between 135° C. and 165° C., depending on the type of adhesive) for the abovementioned stack-up construction represents a threshold point in the compression process, with a dwell time of 30 or 50 minutes regulating the color of the wood veneers and the surface finish on the exposed front and rear layers of the card body.

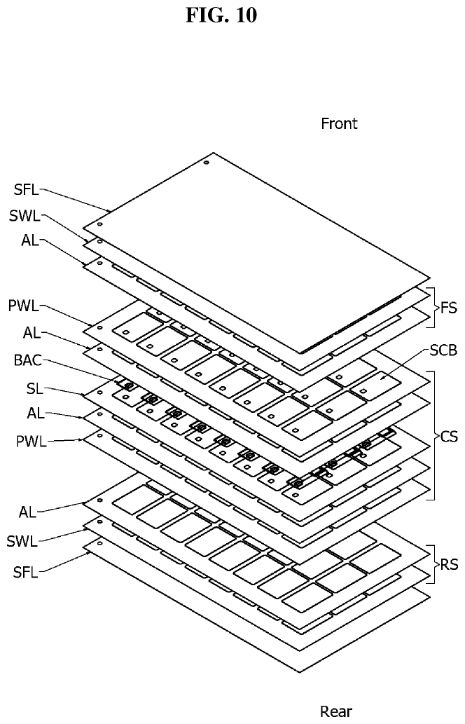

FIG. 10 shows a laminated sheet assembly (stack-up, construction) in a 3×8 format having a plurality of card body sites (SCB) for production of a like plurality of smart card bodies, said laminated sheet having a front (top) exposed surface and a rear (bottom) exposed surface, said laminated sheet assembly comprising 4 wood veneer layers, 4 adhesive layers and a core substrate layer incorporating a booster antenna circuit.

FIG. 10: Description and dimensions of the laminated sheet assembly (LSA) comprising 4 wood veneer layers, 4 adhesive layers and a core substrate layer.

### Top Release Film

| | | | |
|---|---|---|---|
| Layers | Description | Grain direction | Thickness |

| | | |
|---|---|---|
| SFL | Sacrificial layer such | 36 μm |
| | as a PET release film | |

### Front Subassembly (ES)

| | | Grain | | |
|---|---|---|---|---|
| Layers | Description | direction | Thickness | |
| SWL - FS | Front sheet of sliced wood | Lengthwise | 550 | μm |
| | (veneer) layer (WL, SWL) - | | | |
| | wood species: maple | | | |
| AL - FS | Adhesive layer (AL) for bonding | | 25 | μm |

### Core Subassembly (CS)

| Layers | Description | Grain direction | Thickness | |
|---|---|---|---|---|
| PWL - CS | Top sheet of rotary peeled wood (veneer) layer | Crosswise | 200 | μm |
| | (PWL, IWL) - wood species: maple or birch - | | | |
| | 2-ply core subassembly (CS) | | | |
| AL - CS | Adhesive layer in the form of a dry film | | 25 | μm |
| | adhesive (thermoplastic) for interlayer bonding | | | |
| BAC - CS | Array of wire embedded booster antenna | | | |
| | circuits (BAC) formed in the core substrate | | | |
| | layer (SL) and completely submerged (bare | | | |
| | copper wire Ø 80 μm or Ø 112 μm | | | |
| SL - CS | Substrate layer in the form of a paper, plastic or | | 100 | μm |
| | pulp layer, alternatively adhesive coated fleece, | | | |
| | adhesive coated paper or adhesive coated wood | | | |
| | with a thickness of 150-200 μm | | | |
| AL - CS | Adhesive layer in the form of a dry film | | 25 | μm |
| | adhesive (thermoplastic) for interlayer bonding | | | |
| PWL - CS | Bottom sheet of rotary peeled wood (veneer) | Crosswise | 200 | μm |

layer (PWL, IWL) - wood species: maple or
birch- 2-ply core subassembly (CS)

### Rear Subassembly (RS)

| | | Grain | | |
|---|---|---|---|---|
| Layers | Description | direction | Thickness | |
| AL - RS | Adhesive layer (AL) for bonding | | 25 | μm |
| SWL - RS | Rear sheet of sliced wood | Lengthwise | 550 | μm |

(veneer) layer (WL, SWL) -
wood species: maple

### Bottom Release Film

| | | Grain | |
|---|---|---|---|
| Layers | Description | direction | Thickness |

| | | | |
|---|---|---|---|
| SFL | Sacrificial layer such as a PET release film | 36 | μm |
| | Total thickness of the 4-ply construction with | 1,700 | μm |

| | |
|---|---|
| a core substrate layer and 4 inner layers of | |
| adhesive before lamination: | |
| Post lamination thickness of the assembly with | 0.760- |
| ~53-55% shrinkage in thickness: | 0.800 mm |

The weight of the card body (CB) after lamination and singulation may be 3.8+/−0.1 gram for a pure laminated wood card including chip module (CM or TCM: 0.082 g), compared to a plastic card with a weight of 5.3 g. With an in-card booster antenna circuit (BAC), the weight of the card body (CB) including chip (TCM) may be approximately 4.0 grams.

FIG. 11 is an exploded, perspective view of a construction of a 5-ply wooden card having outer layers of sliced wood veneer and inner layers of adhesive coated rotary peeled wood veneer, wherein the adhesive coating functions as an agent for interlayer bonding and to accept the wire embedding of an antenna circuit in the core subassembly.

FIG. 11: Architecture of a 5-ply Wooden Transaction Card (WTC) with a Wire Embedded Booster Antenna Circuit (BAC)

The layers and process steps in the stack-up construction of the wooden transaction card (WTC/SC):
CM/TCM 6 or 8 pin faceplate transponder chip module (TCM) with a module antenna (MA) for inductive coupling with the coupler coil (CC) of an in-card booster antenna (BA) residing in a module opening (MO), or
   the 6 or 8 pin faceplate chip module (CM) may be galvanically connected to an in-card booster antenna (BA);
MA Module antenna (MA) of the transponder chip module (TCM) having for example 15 turns for inductive coupling, or
   the chip module (CM) having bond or termination pads on its face-downside for a TeConnect interconnection to the booster antenna (BA);
MO Module opening (MO) in the form of a stepped cavity (P₁ and P₂) to accept the insertion or implanting of the transponder chip module (TCM) or chip module (CM);
LM Laser marking of personalization data to the topcoat (TC) of the upward facing sliced wood (or wooden) layer (SWL) of the front single-ply wood veneer subassembly (FS)—not shown;

### AFL

Additional Front Layers may include a base coat as an impregnation layer (IL) for waterproofing to seal the pores of the exposed wood veneer in the form of a (screen printed) primer or varnish (PR) which simultaneously acts as an adhesion promoter for the later deposition of UV ink, and post digital printing, a topcoat (TC) in the form of a UV varnish may be applied (screen printed) to protect the underlying artwork. The topcoat of varnish may be laser engravable.
TC Laser engravable topcoat (TC), sprayed-on, roller coated or silk screen printed, in the form of a water-based self-sealer or a varnish to protect the underlying graphic artwork or laser etched features;
AW Artwork—digitally deposited UV ink applied to the primed surface of the top sliced wood layer (SWL);
PR/IL Primer as an adhesion promoter for the deposition of digital ink and to function as impregnation layer (waterproofing);
   Note that the primer may be the same substance as the topcoat, such as UV varnish.
   Alternatively, the exposed wood surface after press lamination may be plasma activated to enhance the adhesion of digital ink and the subsequent application of the topcoat (TC).

### FS

Front Single-Ply Wood Veneer Subassembly (FS) bonded to the Core Subassembly (CS) via an Adhesive Coating (AC):
SWL Top sliced wood layer (SWL: upward facing side) of the front single-ply subassembly (FS) comprising a sliced wood veneer layer orientated in a horizontal grain direction (lengthwise) having an initial thickness of 525 μm; Wood species: maple
AC Adhesive coating (AC) in the form of a thermoplastic adhesive such as PVAc glue (Polyvinyl Acetate) for interlayer bonding, applied (sprayed-on, roller coated, curtain coated or screen printed) to the underside of the top sliced wood veneer layer (SWL) having a thickness of 25 μm, alternatively, application of a dry film adhesive.

### CS

Core Wood Veneer Subassembly (CS)—3-ply Subassembly
PWL Rotary peeled wood veneer layer (Upper PWL) of the core subassembly (CS) comprising a micro thin wood veneer (rotary peeled) orientated in a vertical grain direction (crosswise) having a thickness of 150 μm;
BA Booster antenna comprising an insulated wire conductor (Ø: 80 μm or 112 μm) embedded into the (middle) adhesive coated wood layer (ACW), in forming an antenna circuit in the adhesive coating (AC) of the adhesive coated wood layer (ACW) having for example a 10 turn coupler coil (CC), a 3-4 turn perimeter coil (aka communication coil) and a 4-8 turn extension coil;
ACW Adhesive coated wood acting as a bonding and reinforcement layer, in the form of a rotary peeled wood veneer layer (Middle PWL), wherein the layer of rotary peeled wood veneer (PWL) is coated (sprayed-on, roller coated, curtain coated or screen printed) on both sides with a PVAc adhesive for interlayer bonding and to accept the embedding or scribing of a wire antenna on at least one side, and said wood veneer layer orientated in a horizontal grain direction (lengthwise) having a thickness of 300 μm (AC: 50 μm+PWL: 200 μm+AC: 50 μm);
   Wood species: maple or birch
PWL Rotary peeled wood veneer layer (Lower PWL) of the core subassembly (CS) comprising a micro thin wood veneer (rotary peeled) orientated in a vertical grain direction (crosswise) having a thickness of 150 μm;
   Wood species: maple or birch

### RS

Rear Single-Ply Wood Veneer Subassembly (RS) bonded to the Core Subassembly (CS) via an Adhesive Coating (AC):
AC Adhesive coating (AC) in the form of a thermoplastic adhesive such as PVAc glue (Polyvinyl Acetate) for interlayer bonding, applied (sprayed-on, roller coated, curtain coated or screen printed) to the top side of the bottom sliced wood veneer layer (SWL) having a thickness of 25 μm, alternatively, application of a dry film adhesive;
SWL Bottom sliced wood veneer layer (SWL) of the rear single-ply subassembly (RS) comprising a sliced wood veneer layer orientated in a horizontal grain direction (lengthwise) having an initial thickness of 525 μm;
   Wood species: maple

### ARL

Additional Rear Layers may include the same elements as described in the Additional front layers (AFL), namely an impregnation layer (IL) for waterproofing and a topcoat (TC) to protect underlying printed and laser etched artwork.
PR/IL Primer as an adhesion promoter for the deposition of digital ink and to function as impregnation layer (waterproofing);
   Note that the primer may be the same substance as the topcoat, such as UV varnish.
   Alternatively, the exposed wood surface after press lamination may be plasma activated to enhance the adhesion of digital ink and the subsequent application of the topcoat (TC).
AW Artwork—digitally deposited UV ink applied to the primed surface of the bottom sliced wood layer (SWL);
TC Laser engravable topcoat (TC), sprayed-on, roller coated or silk screen printed, in the form of a water-based self-sealer or a varnish to protect the underlying graphic artwork or laser etched features;
MS Magnetic stripe (2 or 3 tracks (HiCo)) applied and pressed onto or into the topcoat (TC) protecting the downward facing sliced wood layer (SWL) of the rear single-ply subassembly (RS);
LM Laser marking (LM) of personalization data to the topcoat (TC) in downward facing sliced wood layer (SWL) of the rear single-ply subassembly (RS)—not shown;

Security elements (not shown)—signature panel and payment brand hologram.

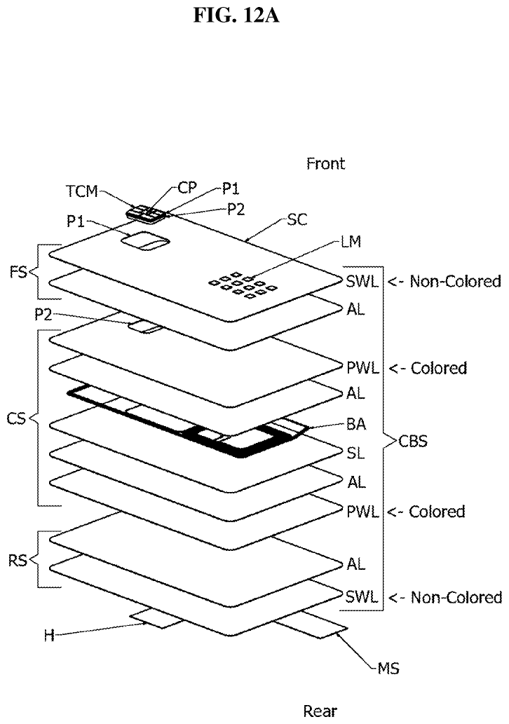

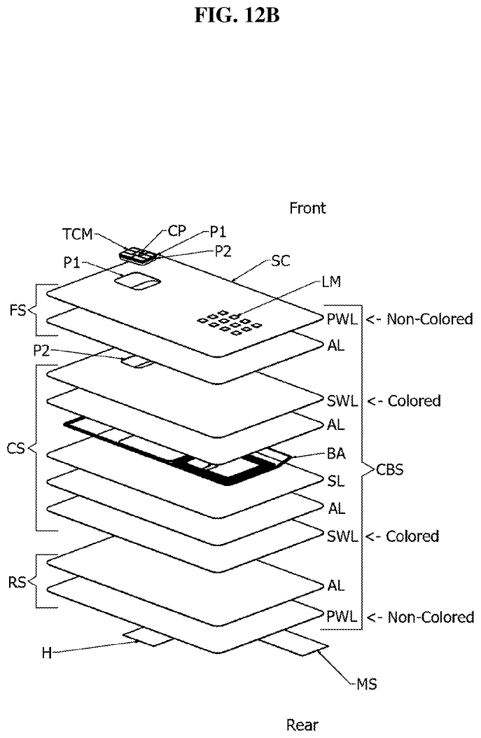

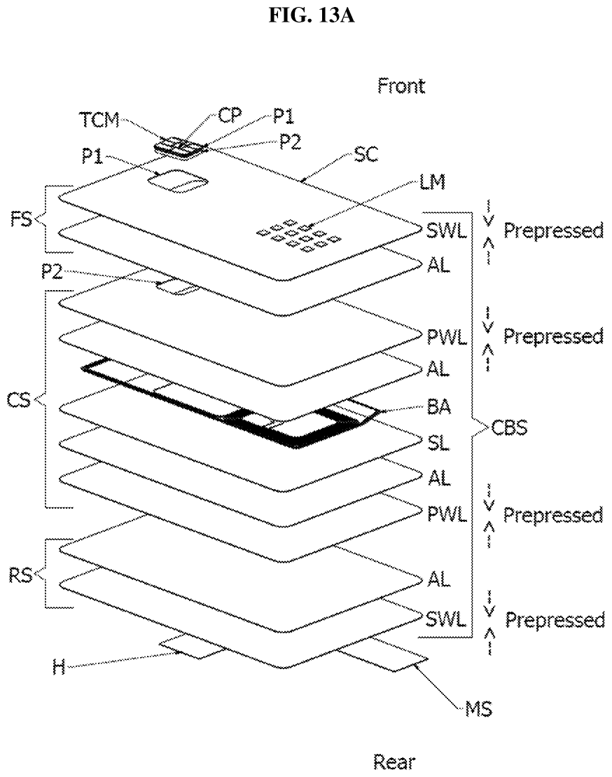

FIG. 12A is an exploded, perspective view of a construction of a 4-ply wooden card having outer (non-stained) layers of sliced wood veneer (SWL) and inner (stained) layers of rotary peeled wood veneer (PWL), adhesive layers (AL) for bonding, and a wire embedded booster antenna circuit (BAC) incorporated in a core substrate layer (SL), and the exposed front and rear surfaces laser marked (LM) with graphic elements.

The front and rear subassemblies (FS & RS) may be mounted to a core subassembly (CS) in forming the stack-up construction of a card body (CB), wherein the core subassembly (CS) comprises dyed wood veneer layers which provide background contrast to the exposed non-colored front and rear wood veneers. The exposed front and rear wood layers may be laser etched to reveal the underlying-colored wood veneer. Put differently, the front and rear non-colored sliced wood veneer (SWL) may be machined to reveal the underlying-colored rotary peeled wood veneer (PWL). The color of the inner rotary peeled wood veneer (PWL) may reflect through the non-colored sliced wood veneer (SWL).

For a given stack-up construction of material layers in forming a card body subassembly or structure (CBS) having a thickness before press lamination of 1650 μm (front non-colored SWL (Maple: 300 μm)+AL (25 μm)+colored PWL (Maple: 425 μm)+AL (25 μm)+core SL (100 μm) with BAC+AL (25 μm)+colored PWL (Maple: 425 μm)+AL (25 μm)+non-colored rear SWL (Maple: 300 μm), the post lamination thickness in applying a pressure of 850 N/cm² at a temperature of approximately 150° C. (between 135° C. and 165° C., depending on the type of adhesive) for a dwell time of 30 minutes is approximately 760-800 μm (representing a shrinkage of 52%).

FIG. 12B is an exploded, perspective view of a construction of a 4-ply wooden card having outer layers of rotary peeled wood veneer (PWL) and inner layers of colored sliced wood veneer (SWL), adhesive layers (AL) for bonding, and a wire embedded booster antenna circuit (BAC) incorporated in a core substrate layer (SL), and the exposed front and rear surfaces laser marked (LM) with graphic elements.

The front and rear layer of rotary peeled wood veneer (PWL) may be assembled to a core subassembly (CS) comprising layers of dyed sliced wood veneer (SWL) which provide background contrast to the exposed non-colored wood veneers. The thicker sliced wood veneers (SWL) forming the core may also provide mechanical strength to the card body construction.

For a given stack-up construction of material layers in forming a card body structure having a thickness before press lamination of 1700 μm (front PWL (Maple: 200 μm)+AL (25 μm)+SWL (Maple: 550 μm)+AL (25 μm)+core SL (100 μm) with BAC+AL (25 μm)+SWL (Maple: 550 μm)+AL (25 μm)+rear PWL (Maple: 200 μm), the post lamination thickness of the assembly, in applying a pressure of 850 N/cm² at a temperature of approximately 150° C. (between 135° C. and 165° C., depending on the type of adhesive) for a dwell time of 30 minutes is approximately 760-800 μm (representing a shrinkage of 53%) without a preconditioning cycle to remove moisture.

The layers of wood veneer forming the card body construction as mentioned above may be replaced by heat and steam treated wood veneers which are water resistant, also known as ThermoWood.

### ThermoWood®

ThermoWood is a sustainable and durable wood product that is enhanced with heat and steam. The wood layers (veneers) described herein may be heat treated to enhance their wood characteristics. Reference is made to FI 127004 B.

FI 127004 B (15 Sep. 2017; Lunawood; Halonen et al.), entitled “Procedure for the manufacture of a wood product and a wood product”, incorporated by reference herein, discloses a method of making a wood product from heat-treated wood. Heat-treated wood is wood that has been treated by raising the temperature of the wood above 100° C. and generally about 200° C. and maintaining it at a high temperature and lowering the temperature to ambient. During the treatment, hot air is generally conducted, and the water vapor level is controlled. Reference is also made to: internet lunawood.com/ and internet.thermowood.fi/

### ThermoWood®

Wood properties naturally enhanced with heat and steam. It is a sustainable timber material produced using chemical-free heat treatment.

Thermal modification improves the wood's technical properties and ThermoWood is non-toxic, dimensionally stable, resistant to decay and resin free.

ThermoWood® properties include:
Dimensional stability
Reduced equilibrium moisture content
Improved durability against decay
Reduced thermal conductivity
Resin removed
Consistent color through the wood
Non-toxic material
Reduced splitting strength
Slightly reduced bending strength

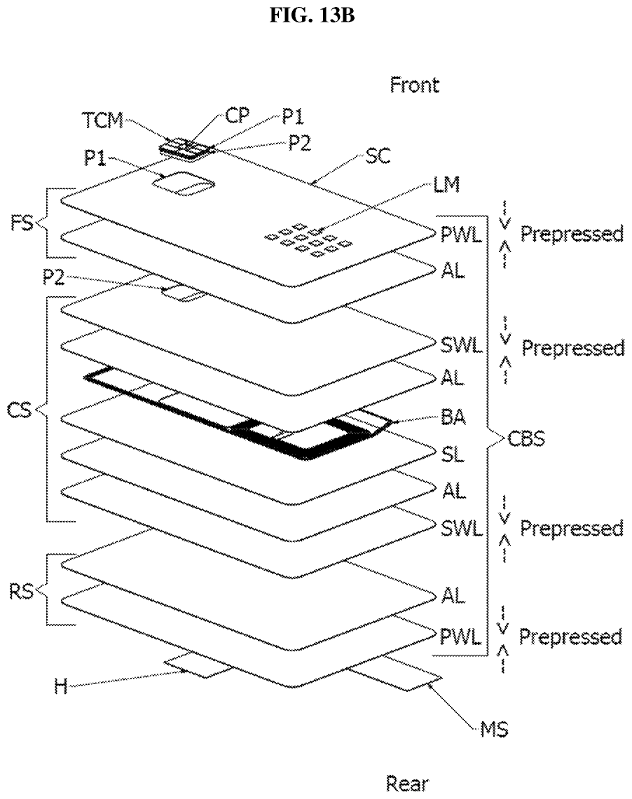

FIG. 13A is an exploded, perspective view of a construction of a 4-ply wooden card having outer (colored or non-colored) layers of sliced wood veneer and inner (colored or non-colored) layers of rotary peeled wood veneer, wherein the wood veneer layers are prepressed before final lamination of the stack-up assembly.

The sliced wood veneers with a thickness of 550 μm may be compressed to a thickness of 275 μm by applying a pressure of 850 N/cm² at a temperature of approximately 150° C. (between 135° C. and 165° C., depending on the type of adhesive) for dwell time of 6 minutes, while the rotary peeled wood veneers with a thickness of 200 μm be compressed to a thickness of 100 μm by applying a pressure of 200-300 N/cm² at a temperature of approximately 150° C. (between 135° C. and 165° C., depending on the type of adhesive) for dwell time of 6 minutes.

FIG. 13B is an exploded, perspective view of a construction of a 4-ply wooden card having outer (prepressed) layers of rotary peeled wood veneer and inner (prepressed) layers of sliced wood veneer.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. Method of making a laminated sheet assembly (LSA) for a wooden transaction card (WTC), comprising:
stacking up multiple wooden (veneer) layers (WL, SWL, PWL), a core substrate layer (SL), and adhesive layers (AL) disposed between adjacent ones of the wooden layers and the core substrate layer, wherein the wooden veneer layers have a moisture content of 6% to 9% and the resulting stack-up has an initial thickness of 1650-1750 μm prior to lamination; and
laminating the stack-up at a defined pressure, temperature, and dwell time to form a laminated assembly having an ISO-conforming post-lamination thickness of 760-800 μm;
wherein the laminated assembly achieves the post-lamination thickness without a preconditioning cycle to remove moisture;
wherein the moisture content of the wooden layers changes during the lamination process; and
wherein the post-lamination thickness is determined by a combination of lamination parameters, the number of wooden layers and type of cut (rotary peeled or sliced), the thickness, density and species of the wooden layers, and the lamination method.

2. The method of claim 1, wherein:
the stack-up is laminated at a pressure of 850 N/cm².

3. The method of claim of claim 1, wherein:
the stack-up is laminated at a temperature of between 135° C. and 165° C., depending on the type of adhesive.

4. The method of claim 1, further comprising:
laminating a plurality of stack-ups which are disposed atop one another with a longer dwell time than a single stack-up at the same pressure and temperature as a single stack-up.

5. The method of claim 4, wherein:
the dwell time during lamination is between 30 and 50 minutes.

6. The method of claim 1, wherein:
the stack-up is laminated in a single lamination step (in a continuous press cycle) with a dwell time of 6-10 minutes.

7. The method of claim 1, wherein:
the wooden layers are produced using different cutting techniques resulting in thicknesses ranging from 125 μm to 550 μm.

8. The method of claim 1, wherein:
prior to laminating, a resulting 4-ply stack-up has a thickness of 1350-1450 μm, and then exerting a pressure under 450-550 N/cm² to achieve an ISO conforming thickness of 760 to 800 μm.

9. The method of claim 8, wherein:
a resulting card body (CB) has a weight of less than 4 grams.

10. The method of claim 1, wherein:
a resulting card body (CB) has a weight of 4 to 4.5 grams.

11. The method of claim 1, further comprising:
singulating individual card bodies (CB) from the laminated sheet assembly; and
milling a module opening (MO; pocket) in the card bodies for receiving a chip module (TCM).

12. The method of claim 1, further comprising:
prior to laminating, thinning (by peeling or slicing thinner) wooden layers are thinned (peeled or sliced thinner) before laminating.

13. The method of claim 1, wherein:
the lamination pressure is less than 5 MPa (500 N/cm²) resulting in material shrinkage to achieve an ISO complaint thickness of 760-800 μm, with the moisture content (MC) of the wooden layers (WL) fluctuating or changing under the application of temperature and pressure.

14. Method of making card bodies for wooden transaction cards comprising:
providing multiple wooden (veneer) layers (SWL, PWL), with a moisture content of 6-9% (ideally 8%, after drying at the mill) for creating a stack-up assembly of a card body assembly;
providing interlayers (AL) of adhesive for bonding and a substrate layer (SL) for reinforcement;
laminating the stack-up assembly of wooden layers and interlayers without a pre-conditioning cycle to remove moisture content;
selecting lamination parameters (pressure, temperature, dwell time) in a continuous press lamination cycle (hot and cold) to compress the layers in the stack-up assembly to an ISO conforming thickness of 760-800 μm;
before laminating the layers, modifying or varying the thicknesses of the wooden layers, adjusting the lamination pressure to achieve a certain degree of shrinkage to achieve an ISO conforming thickness, with the ultimate objective being to achieve a weight for the resulting card body of 4-4.5 grams (including an implanted chip module); and
performing press lamination on the stack-up assembly of wood veneer layers and interlayers.

15. The method of claim 14, wherein:
the wooden layers are of same or different wood species.

16. The method of claim 14, wherein:
the wooden layers are produced from wood logs using different cutting techniques (rotary peeled or sliced) resulting in different thicknesses ranging from 125 μm to 550 μm.

17. Method of making a laminated sheet assembly for a wooden transaction card, comprising:
stacking up multiple wooden layers (SWL, PWL, PWL), a core substrate layer (SL), and adhesive layers (AL) disposed between adjacent ones of the wooden layers and the core substrate layer, wherein the wooden veneer layers have a moisture content of 6% to 9%,
wherein the outer wooden veneer layers have a thickness of 450 μm and the inner wooden veneer layers have a thickness of 150 μm, and the resulting stack-up has an initial thickness of approximately 1400 μm prior to lamination; and
laminating the stack-up at a defined pressure, temperature, and dwell time to form a laminated assembly having an ISO-conforming post-lamination thickness of 760 to 800 μm;
wherein the laminated assembly achieves the post-lamination thickness without a preconditioning cycle to remove moisture;
wherein the moisture content of the wooden layers changes during the lamination process; and
wherein the post-lamination thickness is determined by a combination of lamination parameters, the number of wooden layers and type of cut, the thickness, density and species of the wooden layers, and the lamination method.

18. The method according to claim 17, wherein:
the lamination pressure is less than 5 MPa (500 N/cm²).
